(19) United States
(12) Patent Application Publication
(10) Pub. No.: US 2023/0227980 A1
(43) Pub. Date: Jul. 20, 2023

(54) ALUMINUM ALLOY PRETREATMENT WITH PHOSPHORUS- CONTAINING ORGANIC ACIDS FOR SURFACE MODIFICATION

(71) Applicant: Novelis Inc., Atlanta, GA (US)

(72) Inventors: Michèle Edith Berner, Sion (CH); Mathilde Guèrin, Sierre (CH); Holger Frauenrath, Lausanne (CH); Reuben Yeo, Lausanne (CH); Enzo Bomal, Lausanne (CH)

(73) Assignee: Novelis Inc., Atlanta, GA (US)

(21) Appl. No.: 17/998,590

(22) PCT Filed: Jun. 9, 2021
(86) PCT No.: PCT/US2021/036527

§ 371 Date: Nov. 11, 2022

Related U.S. Application Data
(60) Provisional application No. 62/705,095, filed on Jun. 10, 2020.

(51) Int. Cl. C23C 22/03; C23C 22/73; C23C 22/78; C22C 21/00; C23C 22/56

(52) U.S. Cl. CPC C23C 22/03; C23C 22/73; C23C 22/78; C22C 21/00; C23C 22/56

(57) ABSTRACT

Described are techniques for making aluminum alloy products and methods for pre-treating aluminum alloys with small molecules, and the resultant aluminum alloy products, in which small molecules including phosphorus-containing organic acid functionality, such as organo-phos-phonic acids, are applied to a surface of an aluminum alloy product to generate a self-assembled monolayer or multilayer of small molecules on the surface of the aluminum alloy product. Mixtures of different phosphorus-containing organic acids may be employed. At least some of the phospho-ms-containing organic acids may exhibit a hydrophilic character, such as by including one or more hydrophilic functional groups. The self-assembled monolayer or multilayer including hydrophilic functionality may advantageously allow the aluminum alloy product to have a good wettability by water and other hydrophilic substances, such as some epoxy adhesives, but also to have a good wet-tability by hydrophobic substances, such as some lubricants.

### CROSS-REFERENCE TO RELATED APPLICATIONS

This application claims the benefit of and priority to U.S. Provisional Application No. 62,7705,095, filed on Jun. 10, 2020, which is hereby incorporated by reference in its entirety.

### FIELD

The present disclosure relates to metallurgy generally and more specifically to pretreatment of aluminum alloy surfaces with small molecules in order to modify surface characteristics of the aluminum alloy,

### BACKGROUND

Pretreatment of aluminum alloy surfaces may be useful for changing various surface characteristics, For example, anodizing an aluminum alloy surface may enhance the corrosion resistance and toughness of the surface. Surface texturing, such as by electric discharge texturing, may reduce rolling lines typically present in rolled aluminum alloy products. Some surface pretreatrnents, however, may generate a residue that alters the surface's compatibility with other pretreatments and/or may generate a surface that is more prone to corrosion.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

In a first aspect, described herein are methods, such as methods for making and/or treating aluminum alloy products. A method of this aspect may comprise providing an aluminum alloy product; applying one or more phosphorus-containing organic acids to a surface of the aluminum alloy product to generate a self-assembled monolayer or multilayer on the surface of the aluminum alloy product, such as where at least a portion of the phosphorus-containing organic acids are hydrophilic-functionalized phosphorus-containing organic acids. The one or more phosphorus-containing organic acids may be small molecules each having molecular weights of less than=1000 g/mol. The one or more phosphorus-containing organic acids may be selected from the group consisting of hydroxyl-functionalized phosphorus-containing organic acids, amino-fimctionalized phosphorus-containing organic acids, and sulfhydryl (thiol)-functionalized phosphorus-containing organic acids. The aluminum alloy product with the self-assembled monolayer or multi layer may exhibit a contact angle with a lubricant of less than 90°. Methods of this aspect may further comprise applying the lubricant to the surface of the aluminum alloy product. In some cases aqueous lubricants may be used. In other cases, non-aqueous lubricants may be used, In some cases both aqueous lubricants and non-aqueous lubricants may be used.

Different phosphorus-containing organic acids may be used. A phosphorus containing organic acid can have a phosphorus-based acid group (e.g., a phosphoric acid group, —PO (OH)₂, or a phosphinic acid group, —PO (OH)H) and an organic component R (e.g., an alkyl group or an alkynyl group). A phosphorus containing organic acid that is functionalized refers to a functionalized organic group (G) bonded to a phosphorus-based acid group —PO (OH)₂ or —PO (OH)I1), such as G—PO(OH)₂ or G—PO (OH)H. Example functionalized organic groups may contain —OH groups, —NH₂ groups, —SH groups, —PO (OH)₂ groups, —PO (OH)H groups, —SO₃H groups, epoxy groups, acrylate groups, ethynyl groups, or any combination of these. As one example, a hydroxyl-functionalized phosphorus-containing organic acid can contain one or more —OH groups bonded to or as a component of an organic group R, with the —OH groups bonded to the organic group R being distinct from any —OH groups directly bonded to a phosphorus atom in a phosphorus-based acid group. As another example, a thiol-functionalized phosphorus-containing organic acid can contain one or more —SH groups bonded to or as a component of an organic group R, with the —SH groups bonded to the organic group R being distinct from any —OH groups directly bonded to a phosphorus atom in a phosphorus-based acid group. In further examples, one or more of the phosphorus-containing organic acids may be or comprise a phosphoric acid, such as where one or more of the phosphorus-containing organic acids may have a formula of: R—PO(OH)₂, where R is a functionalized or unfunctionalized alkyl group, a functionalized or unfunctionalized alkenyl group, a functionalized or unfunctionalized alkynyl group or any combination of these. R may be functionalized with one or more —OH groups, —NH₂. groups, —SH groups, —PO(OH)₂ groups, —PO(OH)H groups, —SO₃H groups, trialkoxysilyl groups, vinyl groups, ethynyl groups, epoxy groups, acrylate groups, or any combination of these. One or more of the phosphorus-containing organic acids may have a formula of: X—(CR¹R²)ₙ—PO(OH)₂, where n is an integer from 3 to 30, where each R¹ and R² are independently a hydrogen, a functionalized or unfunctionalized alkyl group, a functionalized or unfunctionalized alkenyl group, or a functionalized or unfunctionalized alkynyl group, and where X is an —OH group, an —NH₂ group, or an —SH group, One or more R¹ or R² may be functionalized with one or more —OH groups, —NH₂ groups, —SH groups, —PO(OH)₂ groups, —PO(OH)H groups, —SO₃H groups, trialkoxysilyl groups, vinyl groups, epoxy groups, ethynyl groups, acrylate groups, or any combination of these. One or more of the phosphorus-containing organic acids have a formula of: X—(CH₂)ₙ—PO (OH)₂, where n is an integer from 3 to 30, and where X is an —OH group, an —NH₂ group, or an —SH group, The one or more phosphorus-containing organic acids have molecular weights of less than 600 g/mol.

Applying the one or more phosphorus-containing organic acids to the surface of the aluminum alloy product may comprise applying a mixture containing the one or more phosphorus-containing organic acids and a carrier to the surface of the aluminum alloy product. Useful carriers may comprise one or more of water, an alcohol, an organic solvent, or a lubricant. The one or more phosphorus-containing organic acids may be in a dissolved or suspended state in the carrier. The one or more phosphorus-containing organic acids may be applied to the surface of the aluminum alloy product as part of a treatment or pretreatment process, such as where the carrier is applied to the surface of the aluminum alloy product. The one or more phosphorus-containing organic acids may be applied to the surface of the aluminum alloy product as part of a lubrication process, such as when the one or more phosphorus-containing organic acids are dissolved or otherwise present in a carrier comprising a lubricant. A concentration of the one or more phosphorus-containing organic acids in the carrier may be from 0.001 g/L to 10 g/L or from 0.01 mM to 100 mM, for example. The one or more phosphorus-containing organic acids may comprise a mixture of two or more different phosphorus-containing organic acids. A molar ratio of a first phosphorus-containing organic acid in the mixture to a second phosphorus-containing organic acid in the mixture may be from or in the range of 1:200 to 200:1. In an example, a first phosphorus-containing organic acid in the mixture comprises a hydrophilic-functionalized phosphorus-containing organic acid and a second phosphorus-containing organic acid in the mixture comprises a different hydrophilic-functionalized phosphorus-containing organic acid. In an example, a first phosphorus-containing organic acid in the mixture comprises a hydrophilic-functionalized phosphorus-containing organic acid and a second phosphorus-containing organic acid in the mixture comprises a phosphorus-containing organic acid lacking a hydrophilic-functional group. Optionally, one or more of the phosphorus-containing organic acids comprise molecules functionalized with multiple phosphorus-containing acids. Optionally, one or more of the phosphorus-containing organic acids comprise molecules functionalized with a phosphorus-containing acid salt including a Ti, Zr, Mo, Na, K, Mg, Ca, Zn, Cr, Ce, Y. Tb, or La ion,

In an example, the one or more phosphorus-containing organic acids consist of or consist essentially of hydroxyl-functionalized phosphorus-containing organic acids. In an example, the one or more phosphorus-containing organic acids consist of or consist essentially Of amino-functionalized phosphorus-containing organic acids. In an example, the one or more phosphorus-containing organic acids consist of or consist essentially of thiol-functionalized phosphorus-containing organic acids. In an example, the one or more phosphorus-containing organic acids consist of or consist essentially of bis-phosphorus-containing organic acids. Optionally, the one or more phosphorus-containing organic acids consist of or consist essentially of any combination of hydroxyl-functionalized phosphorus-containing organic acids, amino-functionalized phosphorus-containing organic acids, thiol-functionalized phosphorus-containing organic acids, or his-phosphorus-containing organic acids.

Methods of this aspect may further comprise subjecting the aluminum alloy product to a forming operation to generate a formed aluminum alloy product; and joining the formed aluminum alloy product to a second product to generate a joined product. Joining the formed aluminum alloy product and the second product may comprise applying an adhesive between the formed aluminum alloy product and the second product. The adhesive may be or may comprise an epoxy adhesive, an acrylate adhesive, a rubber-based adhesive, or a polyurethane-based adhesive. Applying the adhesive may form a chemical bond between the adhesive and the self-assembled monolayer or multilayer. The self-assembled monolayer or multilayer increases a strength, longevity, or durability of a joint created by the joining as compared to a comparable joint between a comparable aluminum alloy product lacking the self-assembled monolayer or multilayer and the second product. Joining the formed aluminum alloy product to the second product may comprise welding the formed aluminum alloy product and the second product or mechanically joining the formed aluminum alloy product and the second product. The forming operation may generate less defects in the formed aluminum alloy product as compared to a comparable forming operation using a comparable aluminum alloy product lacking the self-assembled monolayer or multilayer.

A method of this aspect may further comprise subjecting the joined product to a corrosive environment. A method of this aspect may further comprise generating a conversion coating on the aluminum alloy product, the formed aluminum alloy product, or the joined product. A method of this aspect may further comprise generating a chromate conversion coating or a phosphate conversion coating on the aluminum alloy product, the formed aluminum alloy product, or the joined product. A method of this aspect may further comprise generating a titanium conversion coating, a zirconium conversion coating, or a rare earth metal conversion coating on the aluminum alloy product, the formed aluminum alloy product, or the joined product. The second product may be or comprise a second aluminum alloy product, a steel product, a magnesium product, a titanium product, a composite product, or a polymeric product.

A water contact angle with the surface of the aluminum alloy product with the self-assembled monolayer or multilayer may be from or in the range of 0% to 110°, from 0° to 45°, from 0° to 20°, or from 0° to 10°. The aluminum alloy product may be or comprise an aluminum alloy sheet. The aluminum alloy product may be or comprise a 5xxx series aluminum alloy, a 6xxx series aluminum alloy, a 7xxx series aluminum alloy, or an aluminum alloy cladded with a 5xxx series aluminum alloy, a 4xxx series aluminum alloy, or a lxxx series aluminum alloy. The self-assembled monolayer or multilayer may cover only a portion of the surface of the aluminum alloy product or the self-assembled monolayer or multilayer may cover an entirety of the surface of the aluminum alloy product.

In another aspect, metal products are described. An example metal product of this aspect may be or comprise a pretreated metal product. An example metal product of this aspect may comprise an aluminum alloy product having a surface and a self-assembled monolayer or multilayer present on the surface, the self-assembled monolayer or multilayer comprising one or more phosphorus-containing organic acids bonded to the surface. At least a portion of the phosphorus-containing organic acids may be hydrophilic-functionalized phosphorus-containing organic acids. The one or more phosphorus-containing organic acids may be small molecules each having molecular weights of less than=1000 g/mol. The one or more phosphorus-containing organic acids may be selected from the group consisting of hydroxyl-functionalized phosphorus-containing organic acids, amino-functionalized phosphorus-containing organic acids, and sulfhydryl (thiol)-functionalized phosphorus-containing organic acids. One or more of the phosphorus-containing organic acids may be or comprise phosphonic acids.

The disclosed metal product may optionally be formed according to any of the methods described herein. The methods described herein may optionally be useful for making a variety of different metal products described herein.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1A, FIG. 1B, FIG. 1C, FIG. 1D, FIG. 1E, and FIG. IF provide schematic illustrations of an aluminum alloy surface with a self-assembled monolayer of one or more phosphorus-containing organic acids. FIGS. 1A 1B, 1C, and 1D show self-assembled monolayers of individual phosphorus-containing organic acids. FIGS. 1b, 1C, and l D show self-assembled monolayers of mixtures of two different phosphorus-containing organic acids,

FIG. 1G, FIG. 1H, and FIG. 1I provide schematic illustrations of an aluminum alloy surface with one or more phosphorus-containing organic acids in a bilayer configuration, formed, for example, by layer-by-layer self-assembly. FIG. 1G shows a self-assembled bilayer of an individual phosphorus-containing organic acid. FIGS. 1H and 11 show self-assembled bilayers of two different phosphorus-containing organic acids. With this concept of layer-by-layer self-assembly, multilayer configurations are possible with one or more phosphorus-containing organic acids, and are not limited to bilayers.

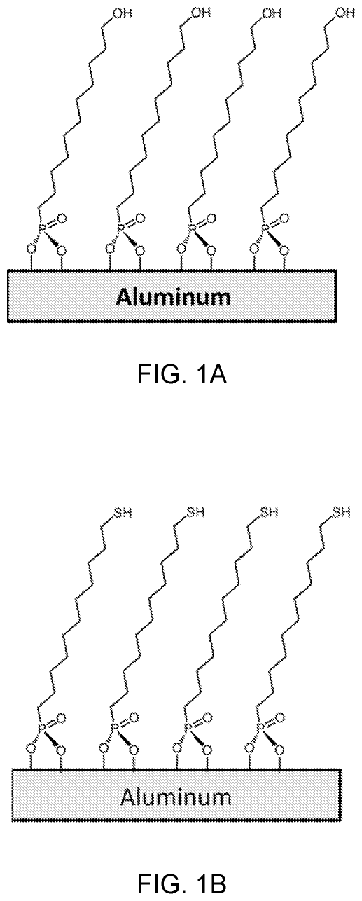

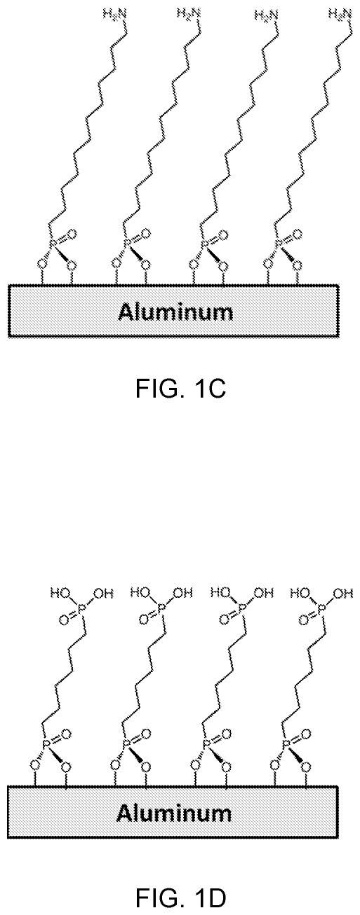

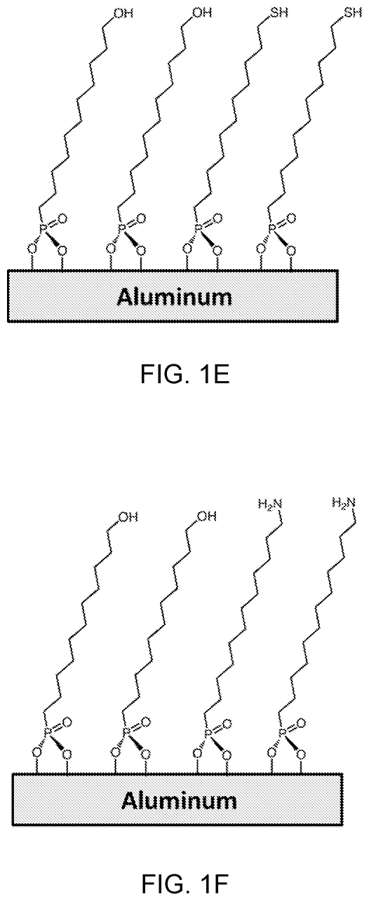

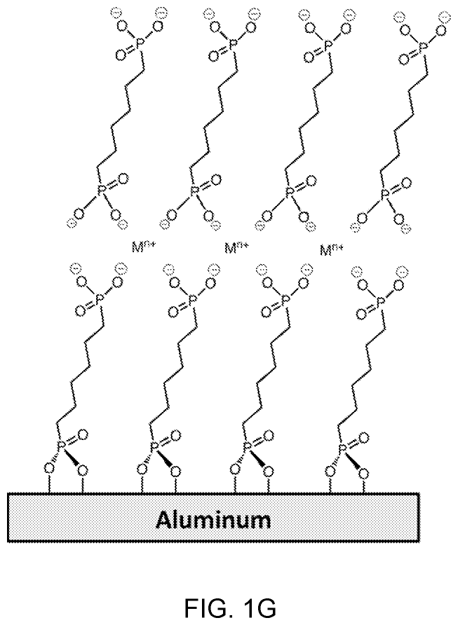

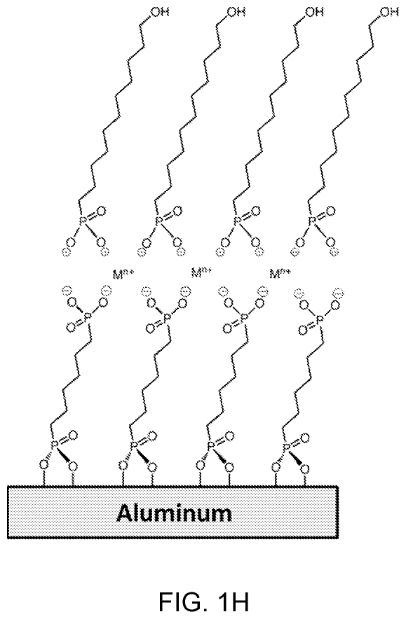

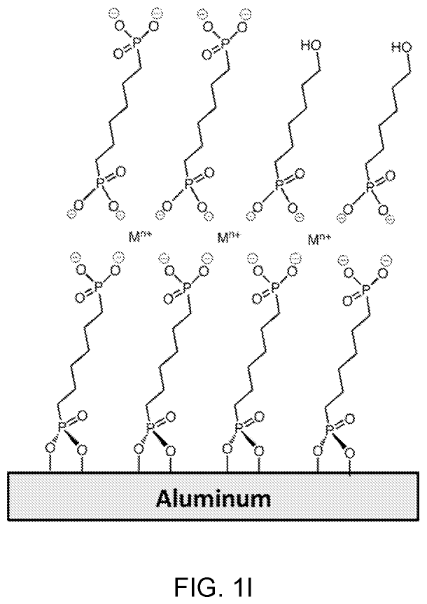

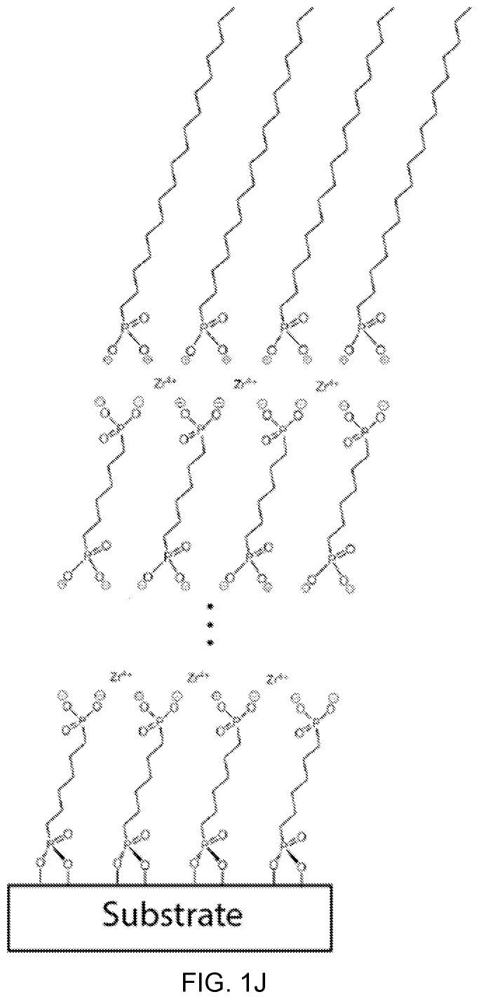

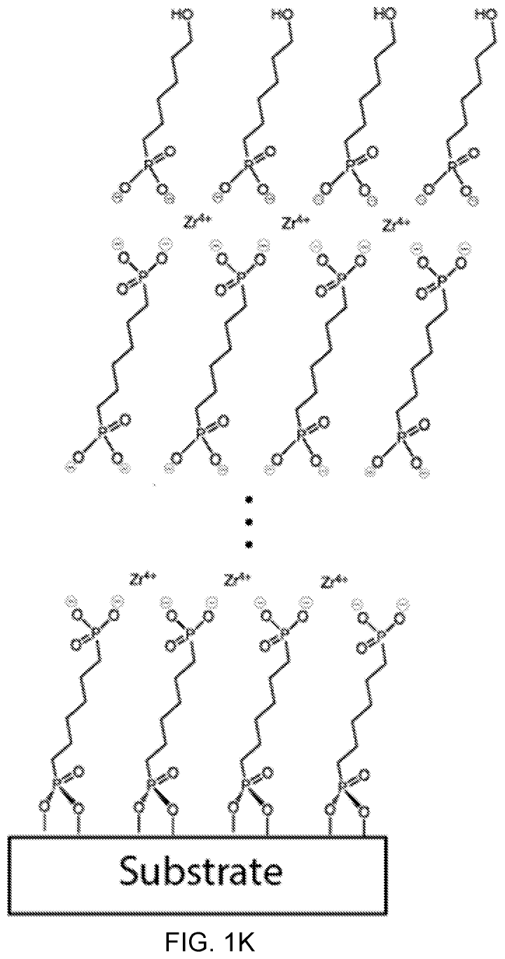

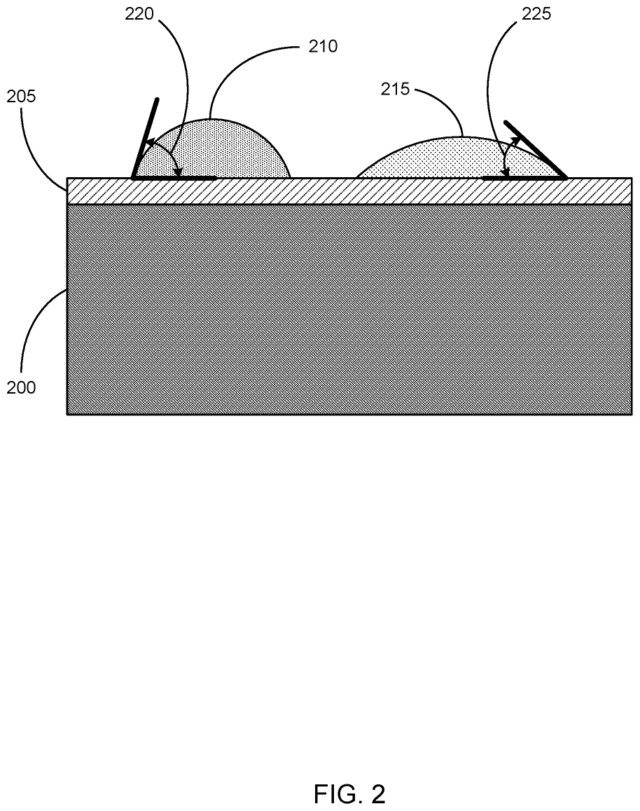

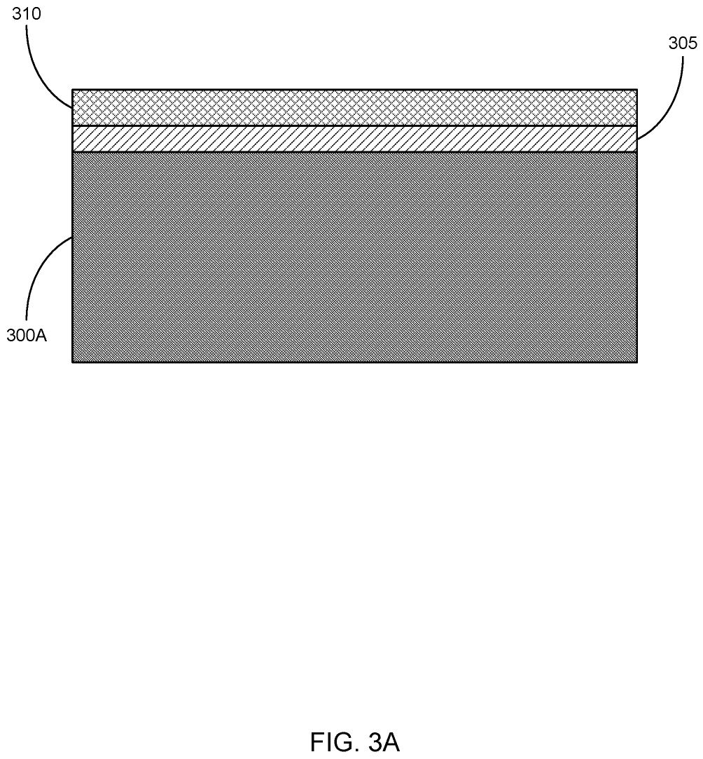

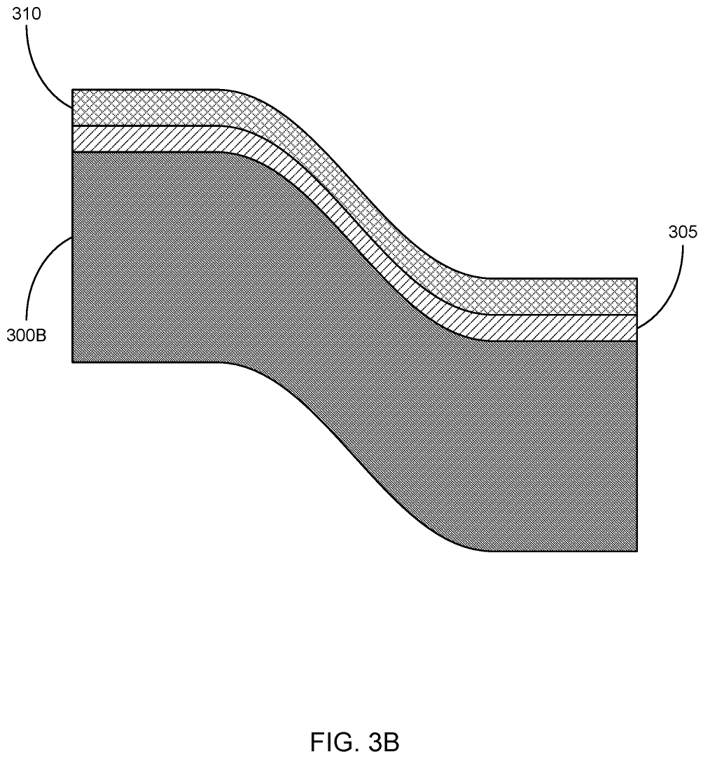

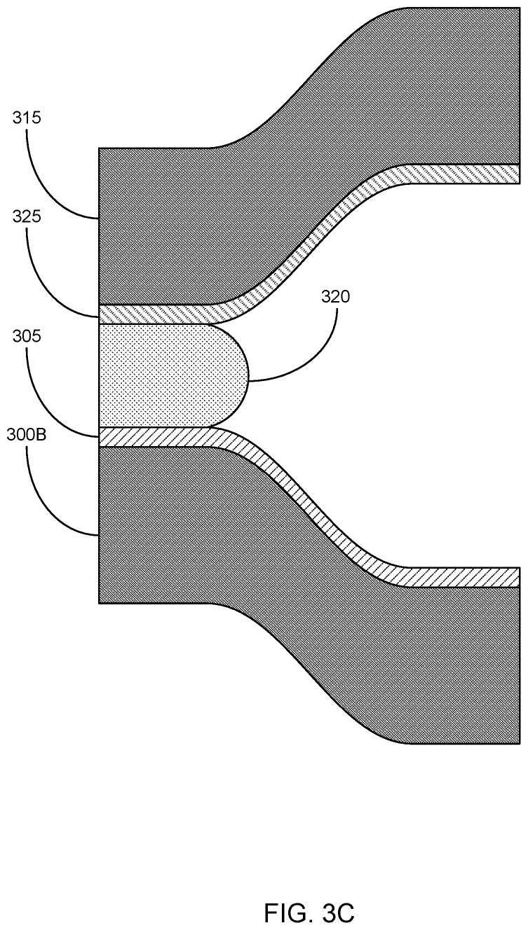

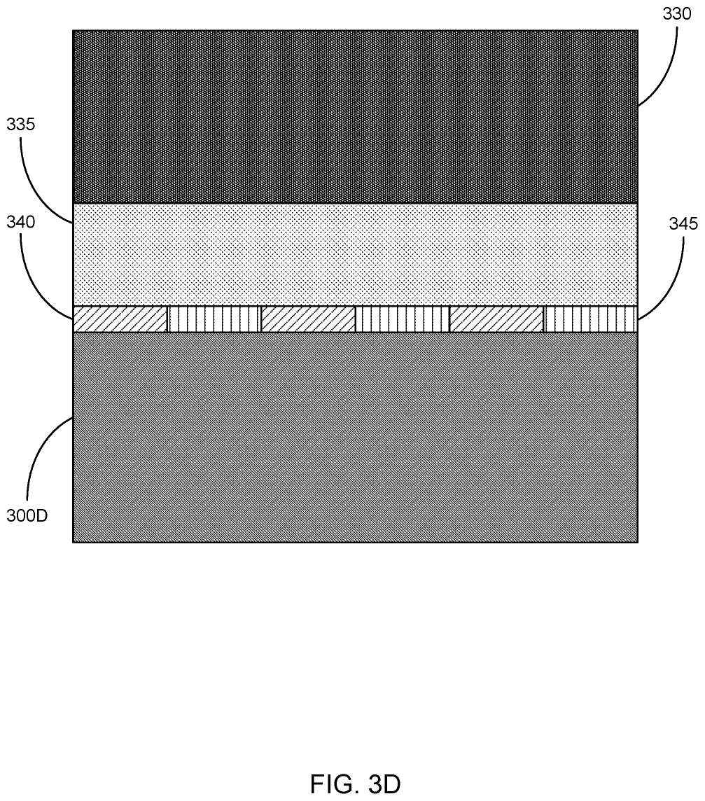

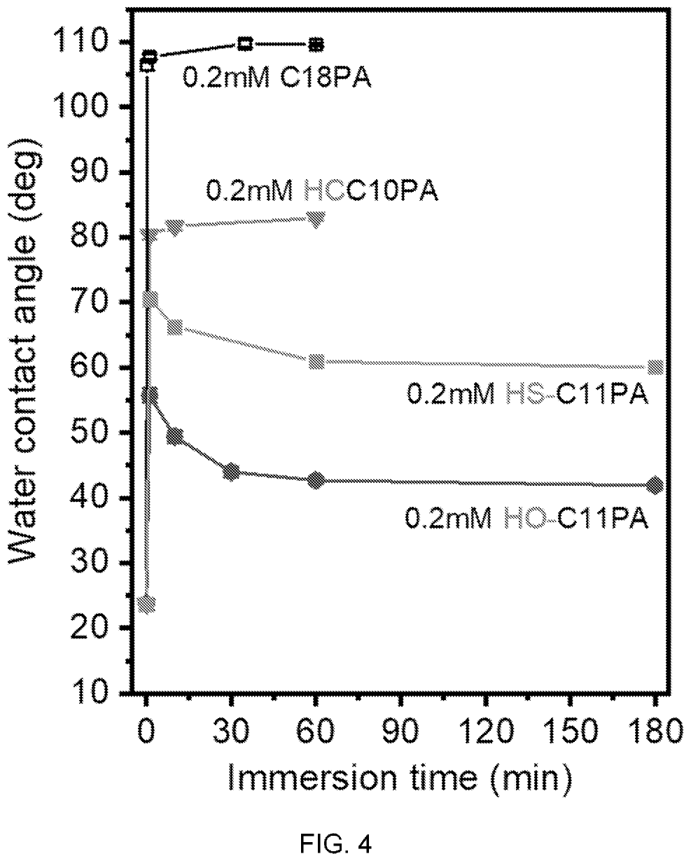

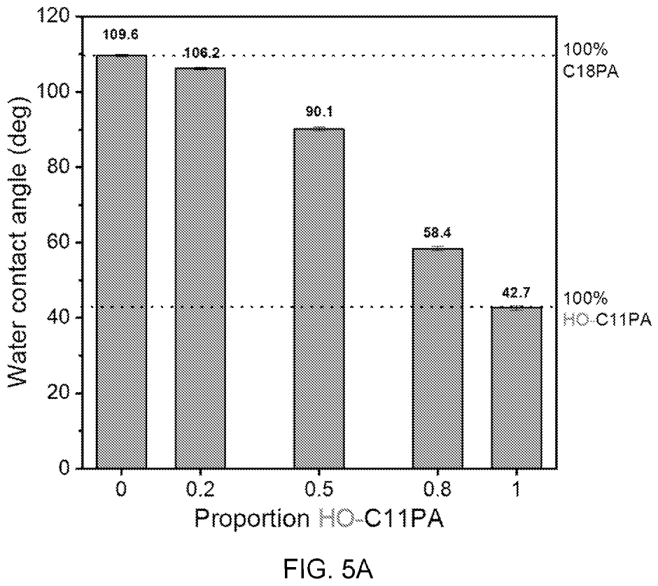

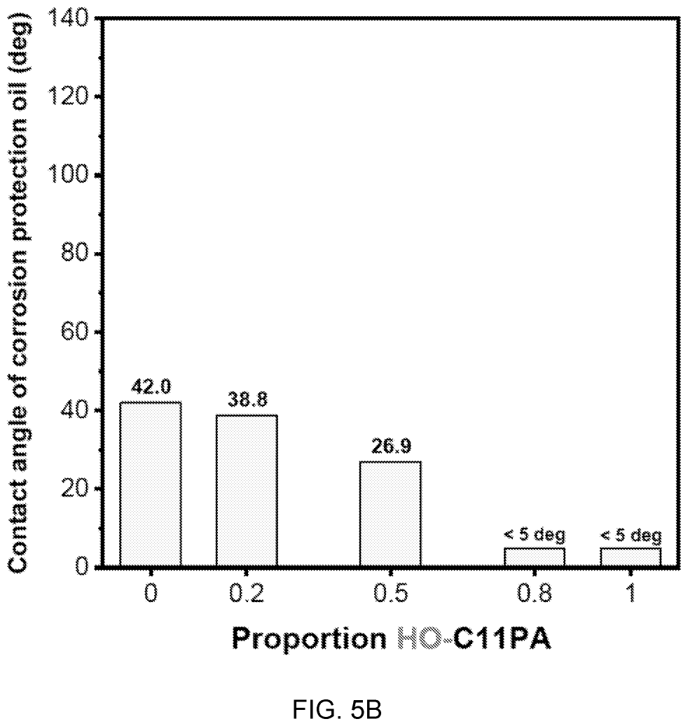

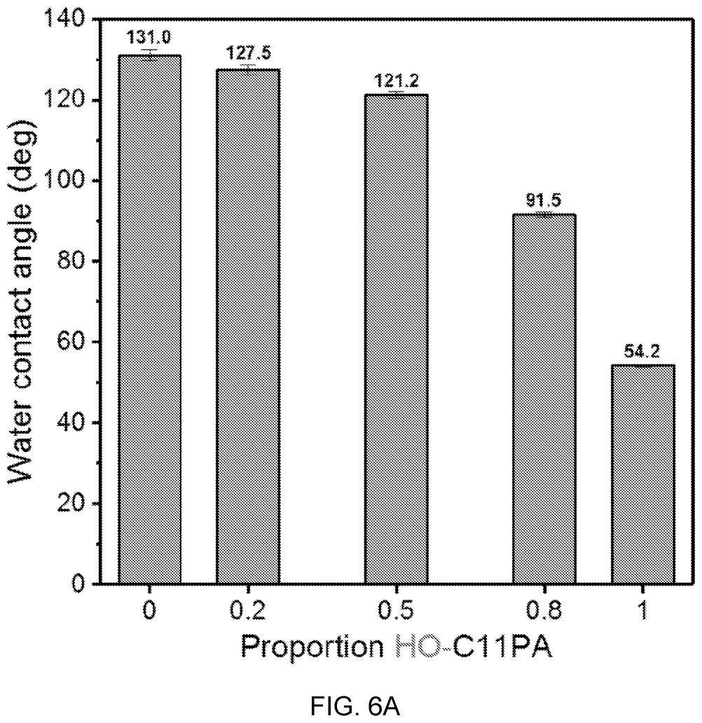

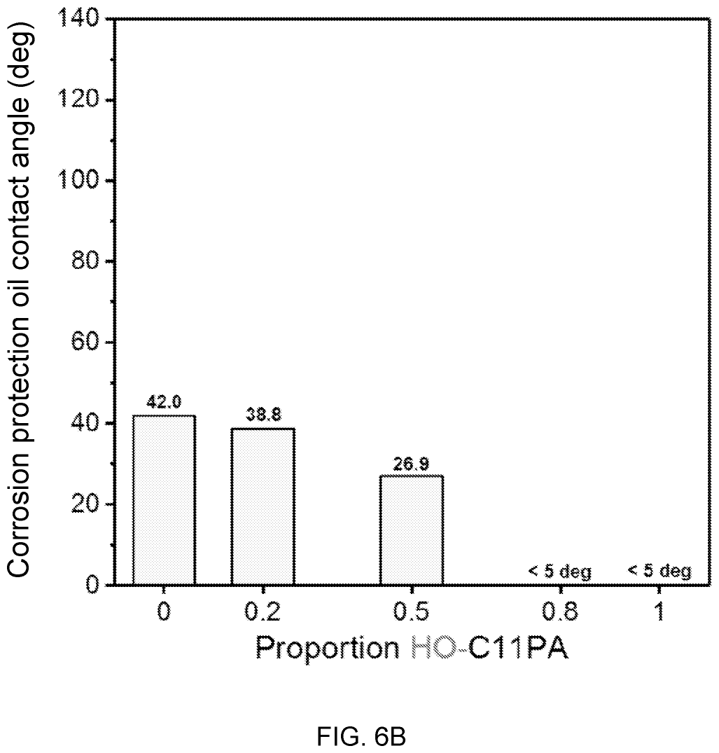

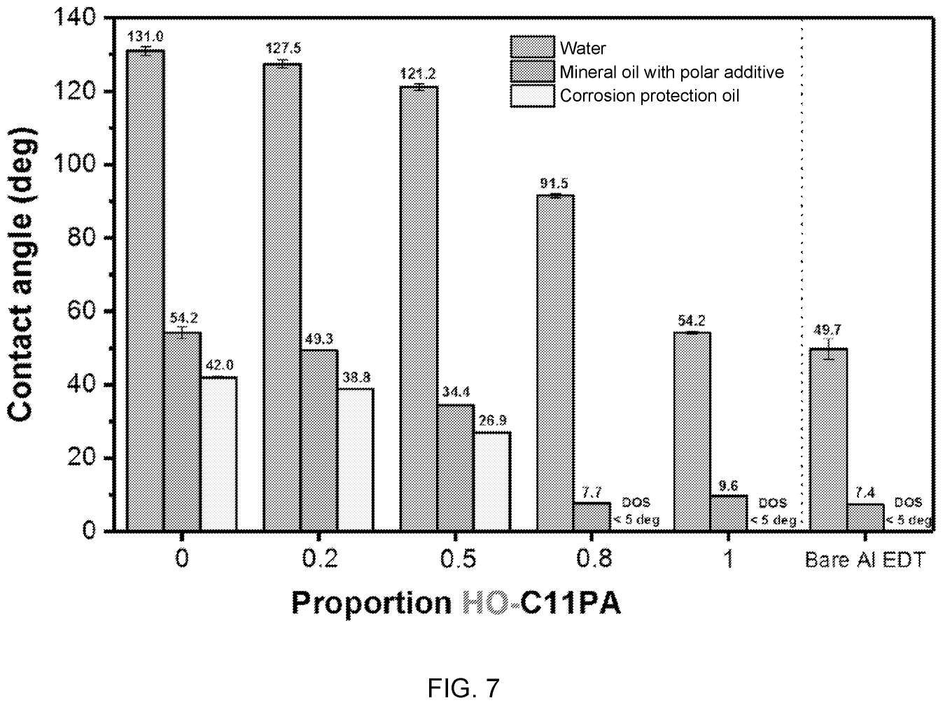

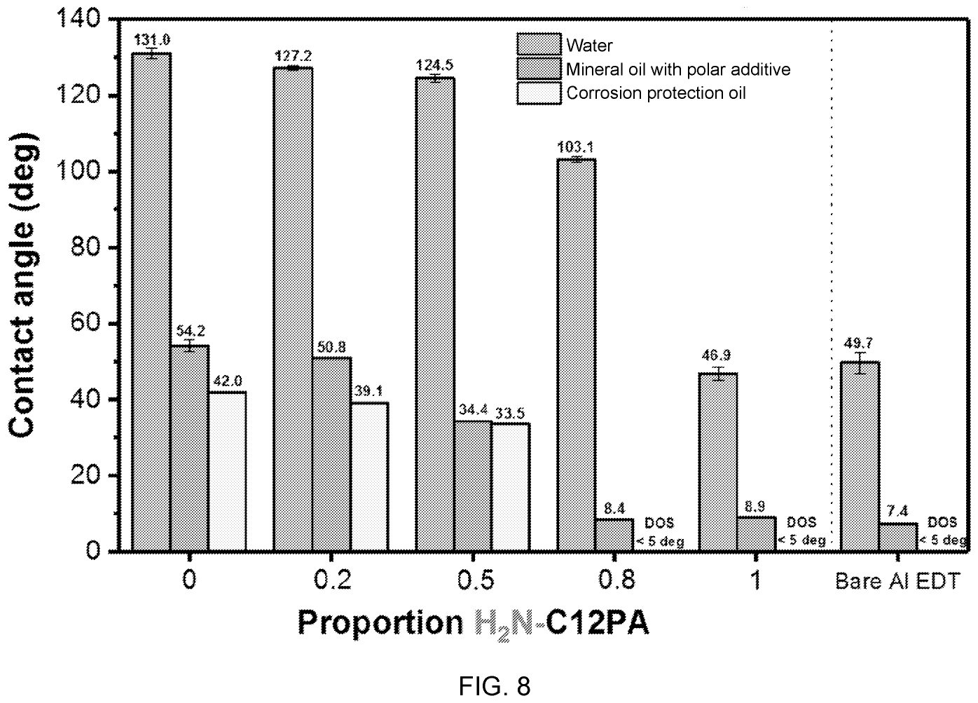

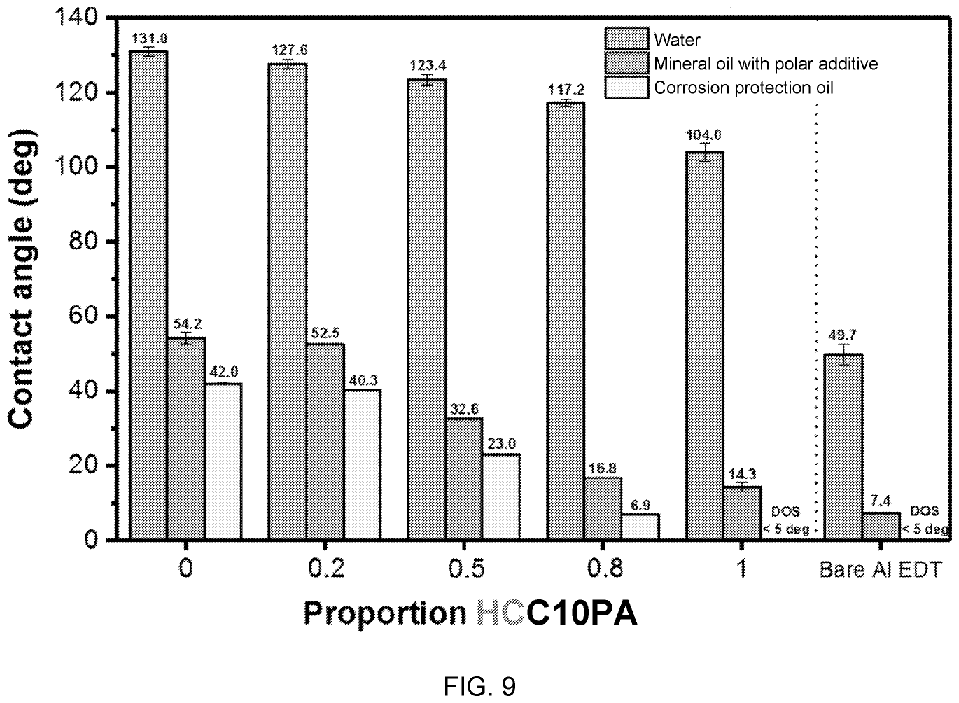

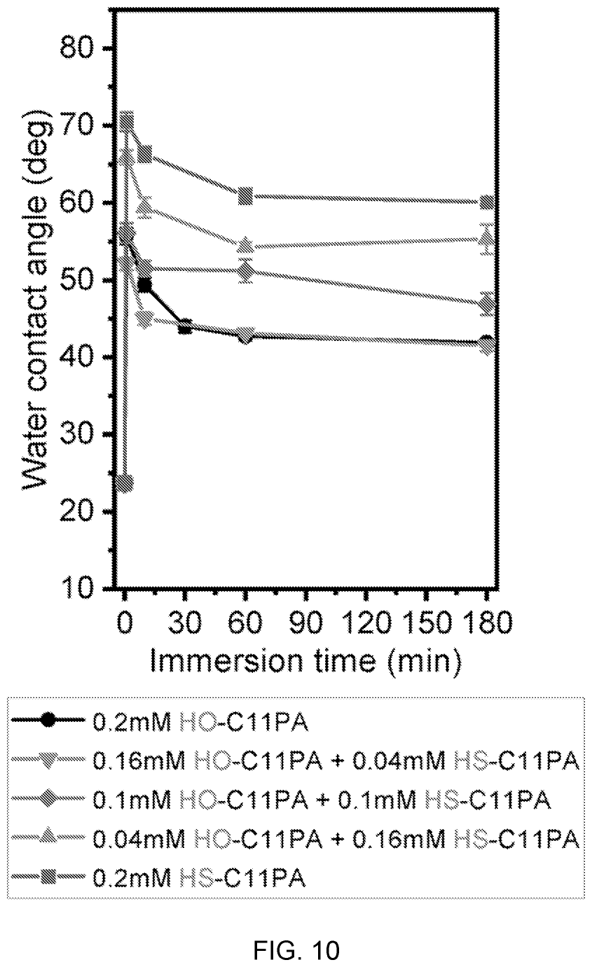

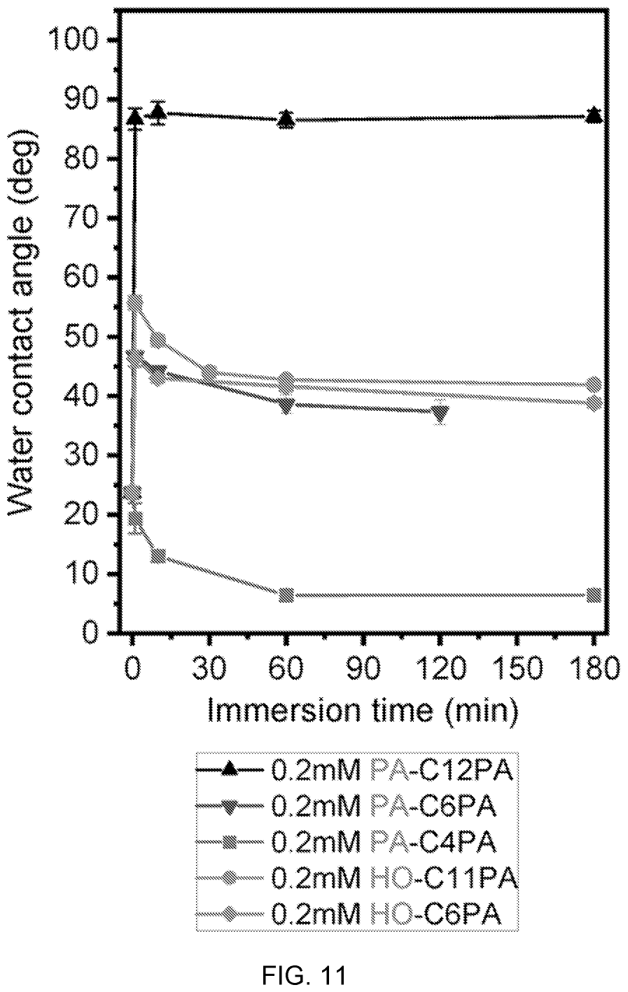

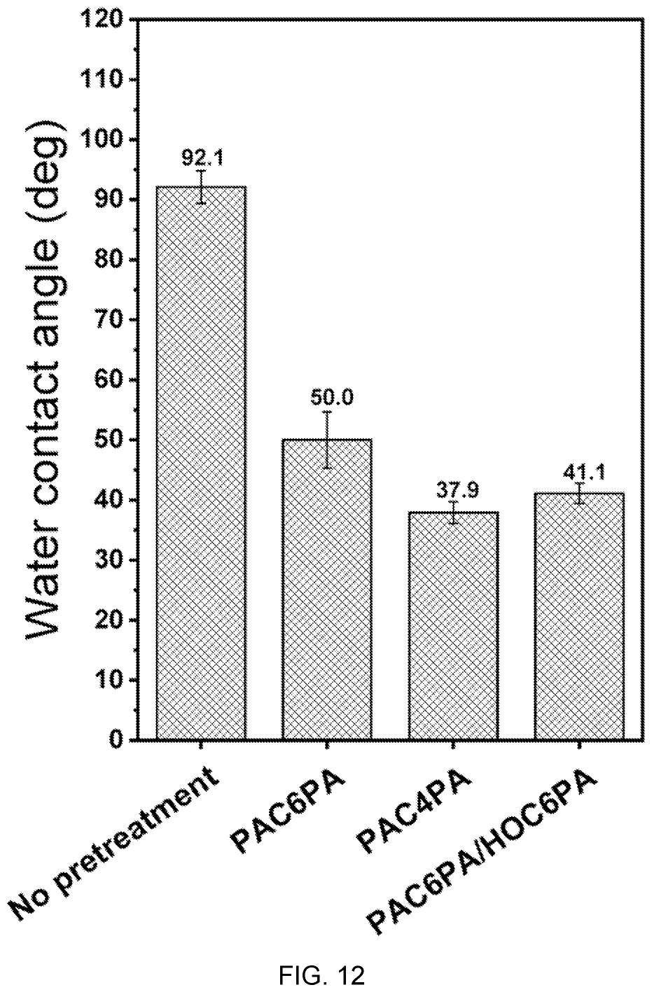

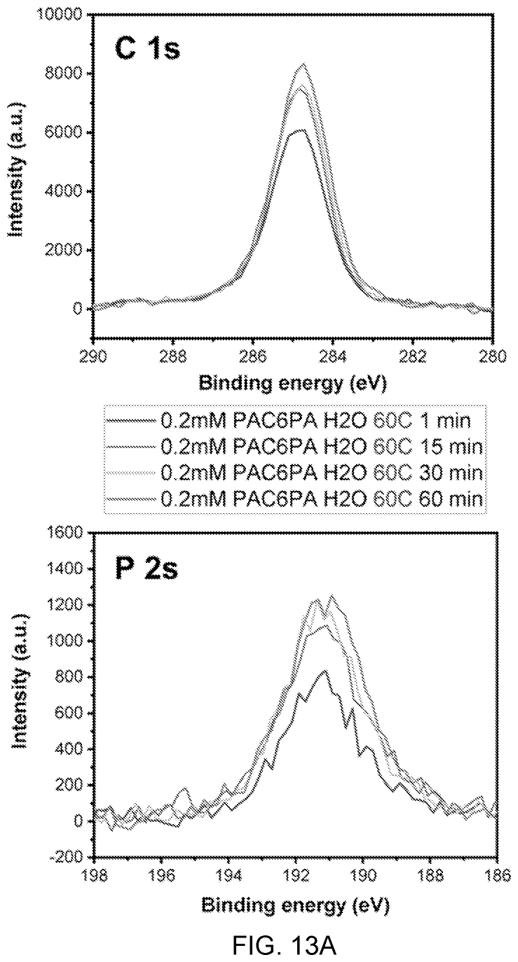

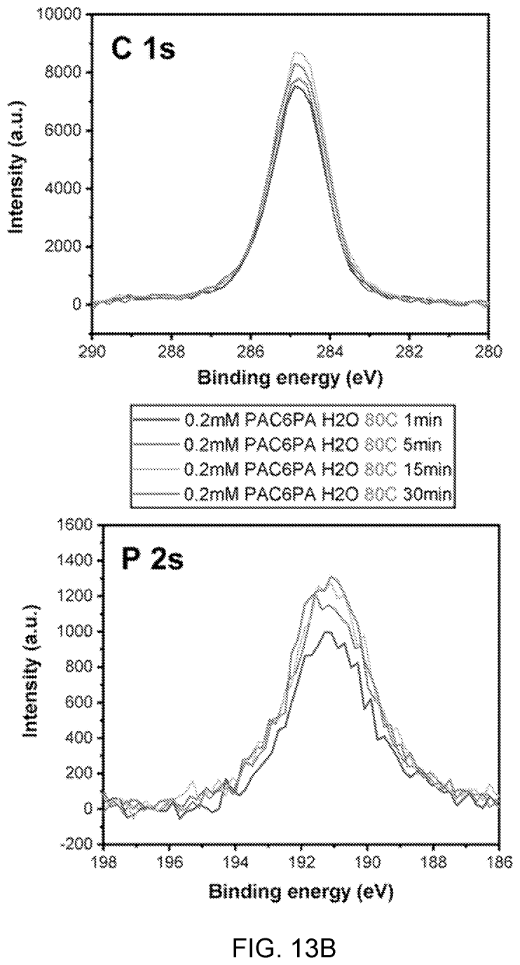

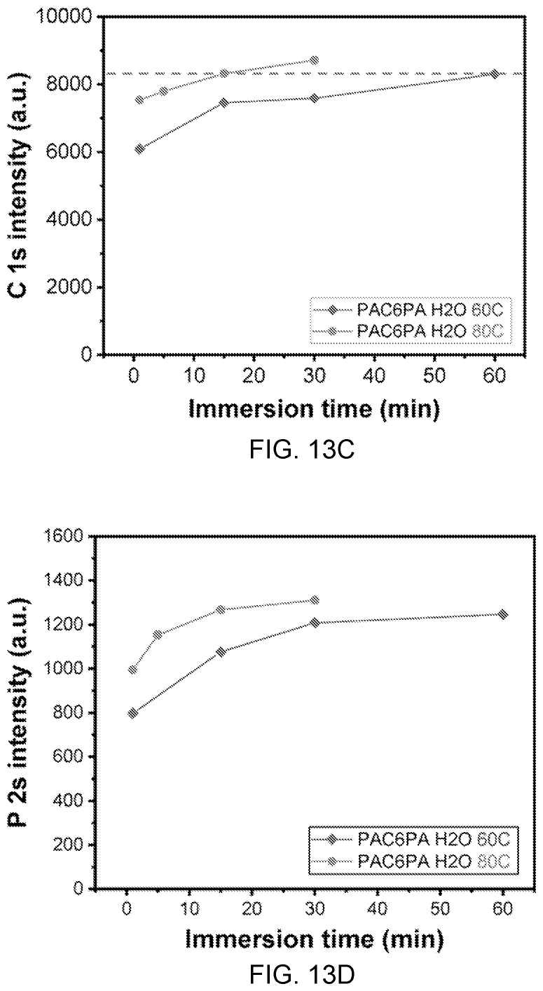

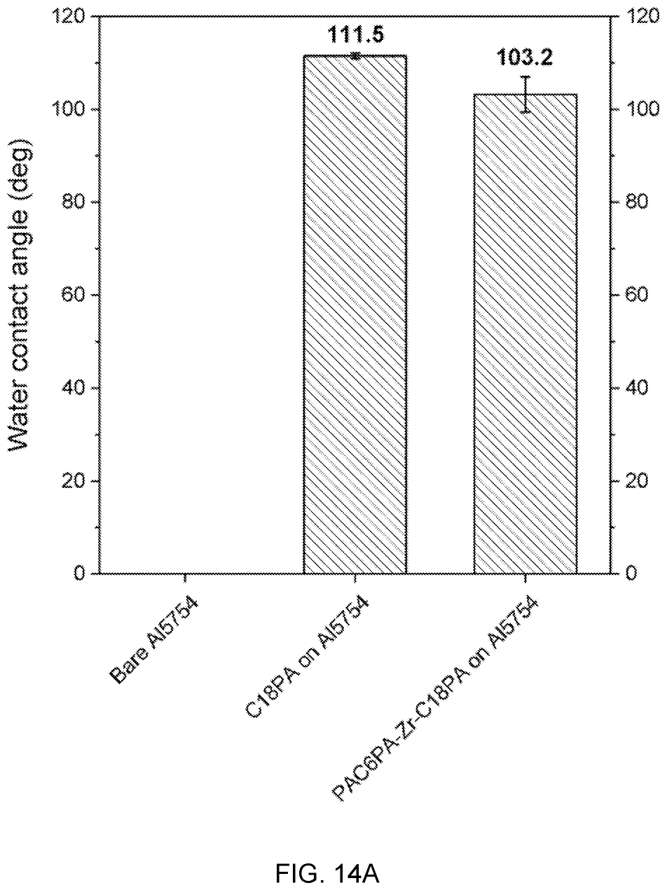

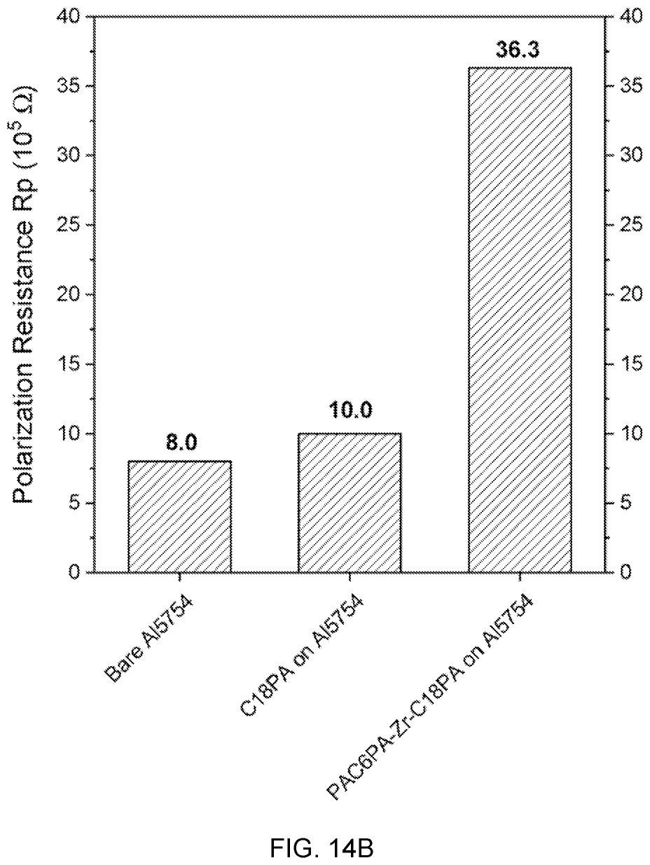

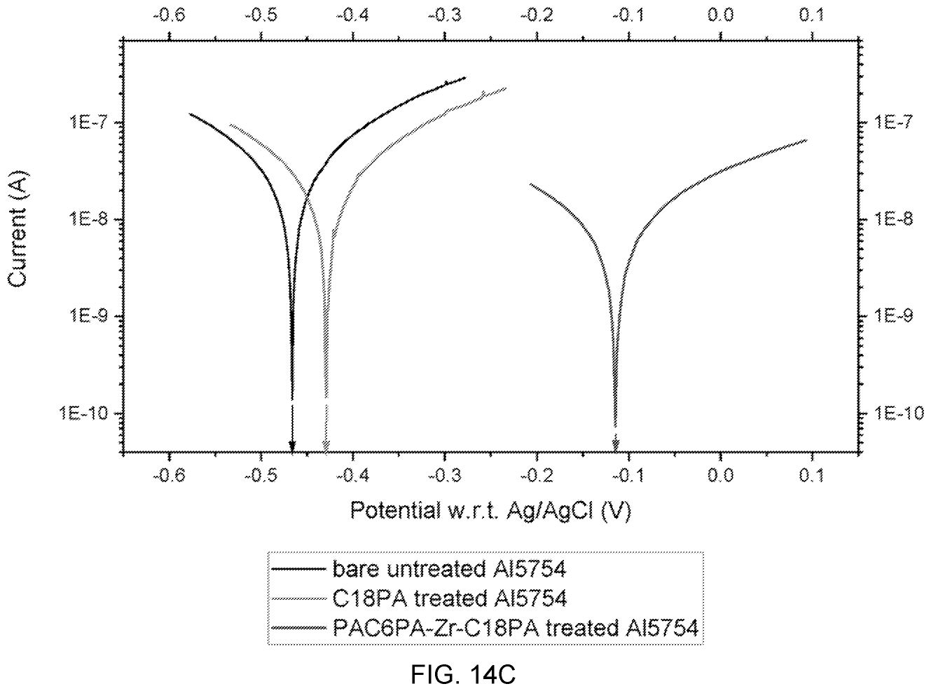

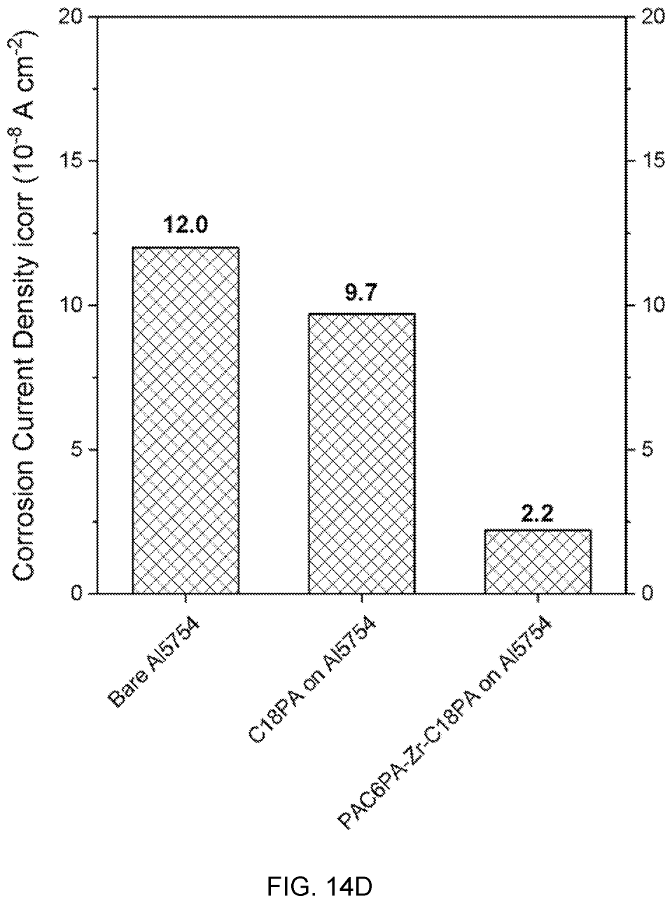

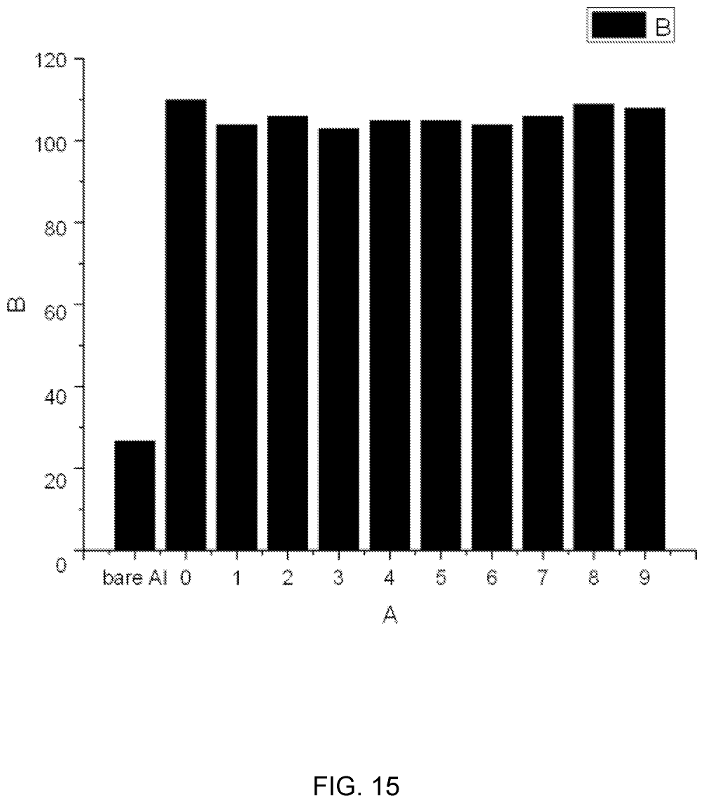

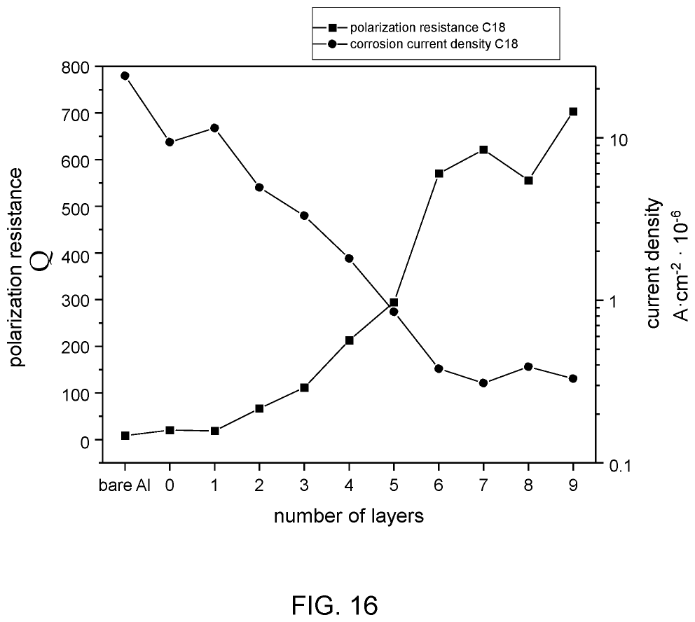

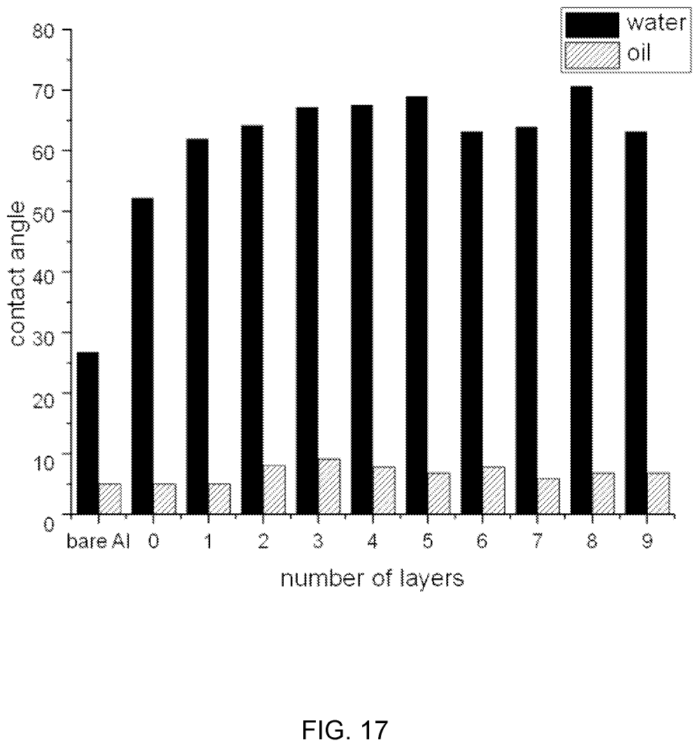

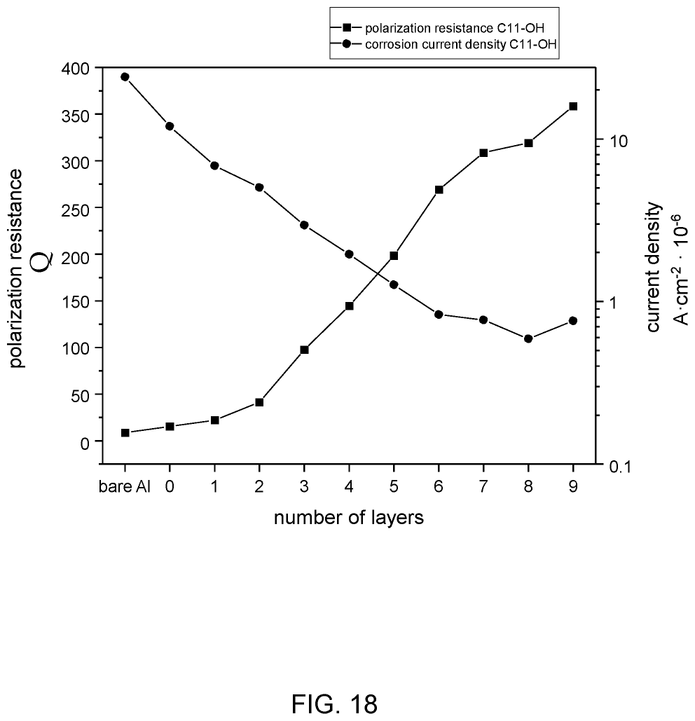

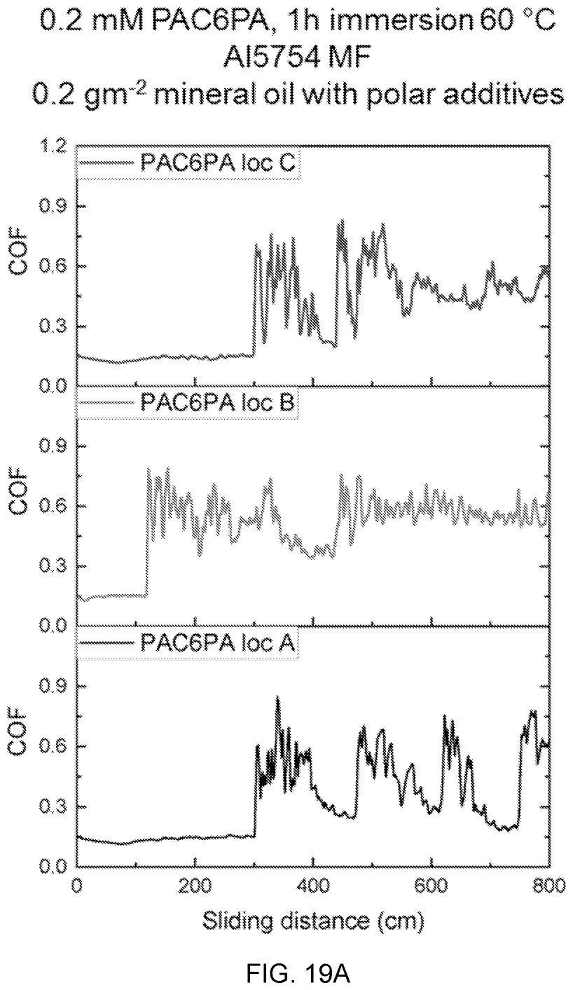

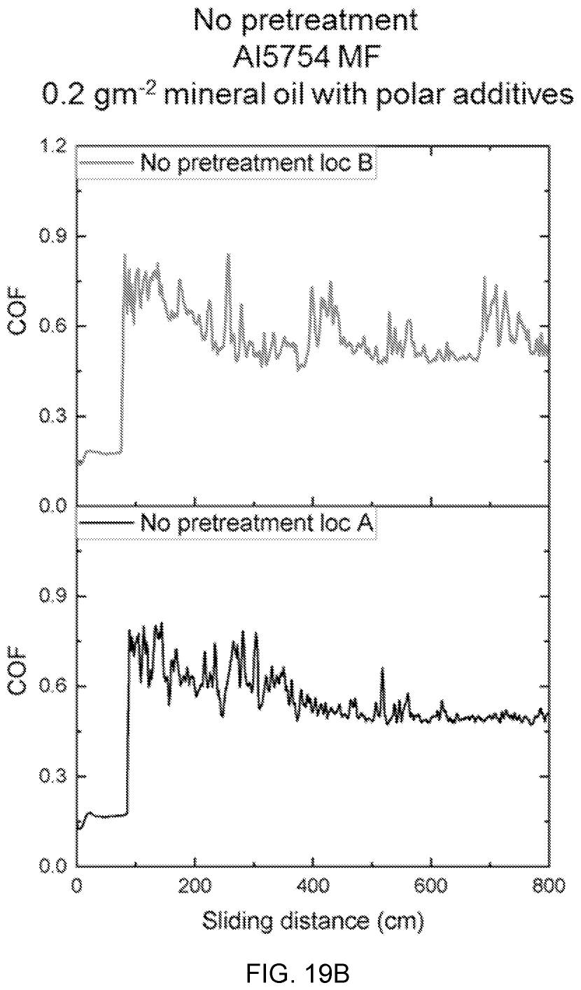

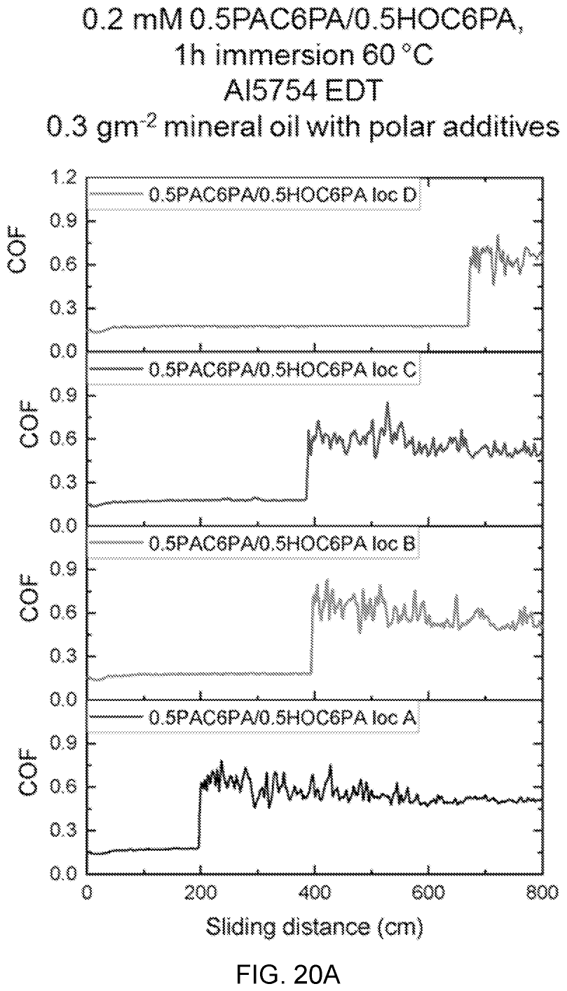

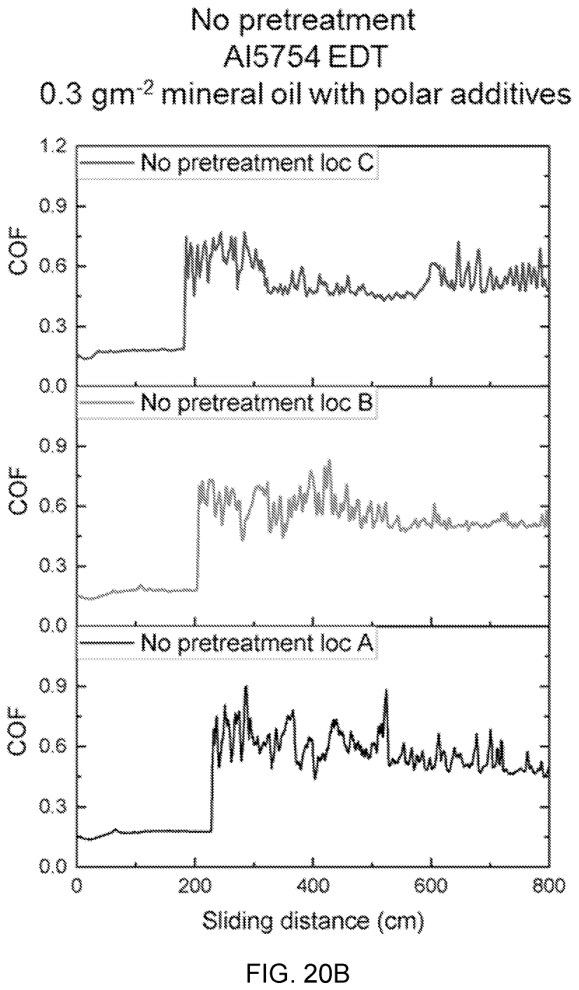

For example, FIG. 1J and FIG. 1K provide schematic illustrations of a substrate, such as an aluminum alloy surface, with one or more phosphorus-containing organic acids in a multilayer configuration, formed, for example, by layer-by-layer self-assembly. FIGS. 1J and 1K show self-assembled multilayers of two different phosphorus-containing organic acids, and show an example where zirconium ions couple different layers. In FIG. 1J, a topmost layer comprises a phosphorus-containing organic acid with hydrophobic functionality, and in FIG. 1K, a topmost layer comprises phosphorus-containing organic acid with hydrophilic functionality.

FIG. 2 provides a schematic illustration of an aluminum alloy surface with a self-assembled monolayer and drops of two different liquids on the surface, showing contact angles for the drops.

FIG. 3A provides a schematic illustration of an aluminum alloy product with a self-assembled monolayer or multilayer and a lubricant layer. FIG. 3B provides a schematic illustration of a formed aluminum alloy product with a self-assembled monolayer or multilayer and a lubricant layer, FIG. 3C provides a schematic illustration of a formed aluminum alloy product with a self-assembled monolayer or multilayer joined to another product by an adhesive. FIG. 3D provides a schematic illustration of a joint between an aluminum alloy product and another product.

FIG. 4 provides a plot showing water contact angles on a smooth aluminum oxide surface pretreated with different phosphorus-containing organic acids in isopropanol-based solutions at 60° C. as a function of immersion time.

FIG. 5A provides data showing water contact angles on a smooth aluminum oxide surface pretreated with mixtures of two phosphorus-containing organic acids in different proportions. FIG. 5B provides data showing contact angle of corrosion protection oil on a smooth aluminum oxide surface pretreated with mixtures of two phosphorus-containing organic acids in different proportions.

FIG. 6A provides data showing water contact angles on an aluminum alloy product with an EDT (electric discharged texturing) surface pretreated with mixtures of two phosphorus-containing organic acids in different proportions. FIG. 6B provides data showing lubricant contact angle on an aluminum alloy product pretreated with mixtures of two phosphorus-containing organic acids in different proportions.

FIG. 7 provides data showing contact angles of different liquids on an aluminum alloy product pretreated with mixtures of two phosphorus-containing organic acids (including a hydroxyl-functionalized organic acid) in different proportions and compares with contact angles of the liquids on an untreated aluminum alloy product.

FIG. 8 provides data showing contact angles of different liquids on an aluminum alloy product pretreated with mixtures of two phosphorus-containing organic acids (including an arnino-functionalized organic acid) in different proportions and compares with contact angles of the liquids on an untreated aluminum alloy product.

FIG. 9 provides data showing contact angles of different liquids on an aluminum alloy product pretreated with mixtures of two phosphorus-containing organic acids (including an alkynyl-functionalized organic acid) in different proportions and compares with contact angles of the liquids on an untreated aluminum alloy product.

FIG. 10 provides data showing contact angles of water on a smooth aluminum oxide surface pretreated with isopropanol-based mixtures of two phosphorus-containing organic acids (including a hydroxyl-fimctionalized organic acid and a thiol-functionalized organic acid) in different proportions at varying immersion time,

FIG. 11 provides data showing contact angles of water on smooth aluminum oxide surfaces pretreated with isopropanol-based solutions of phosphorus-containing organic acids with different chain lengths (four-carbon to eleven-carbon chains) at varying immersion time.

FIG. 12 provides data showing contact angles of water on an aluminum alloy product pretreated with isopropanol-based solutions of phosphorus-containing organic acids of two different carbon chain lengths (including a phosphonic acid-functionalized organic acid), as well as a 50%/50% mixture of two phosphorus-containing organic acids (including a phosphonic acid-functionalized organic acid and a hydroxyl-functionalized organic acid). The data are compared with the contact angles of water on an untreated aluminum alloy product.

FIG. 13A shows X-ray photoelectron spectroscopy (XPS) C 1s and P 2s spectra of smooth aluminum oxide surfaces pretreated with a water-based solution of a phosphorus-containing organic acid at a temperature of 60° C., at varying immersion times. FIG. 13B shows XPS C 1s and P 2s spectra of smooth aluminum oxide surfaces pretreated with a water-based solution of a phosphorus-containing organic acid at a temperature of 80° C., at varying immersion times. FIG. 13C provides data showing the variation of XPS C is peak intensity of smooth aluminum oxide surfaces pretreated with a water-based solution of a phosphorus-containing organic acid at two different temperatures of 60° C. and 80° C., at varying immersion times. FIG. 13D provides data showing the variation of XPS C is peak intensity of smooth aluminum oxide surfaces pretreated with a water-based solution of a phosphorus-containing organic acid at two different temperatures of 60° C. and 80°C., at varying immersion times.

FIG. 14A provides data showing contact angles of water on a polished aluminum alloy product pretreated with a monolayer of a phosphorus-containing organic acid and a bilayer comprising a mixture of two phosphorus-containing organic acids (including a phosphonic acid-functionalized organic acid) and a metal cation that forms a bridge between the sublayers of the bilayer. The data are compared with the contact angles of water on an untreated polished aluminum alloy product. FIG. 14B provides data showing the polarization resistance values of a polished aluminum alloy product pretreated with a monolayer of a phosphorus-containing organic acid and a bilayer comprising a mixture of two phosphorus-containing organic acids (including a phosphonic acid-functionalized organic acid) and a metal cation that forms a bridge between the sublayers of the bilayer. The data are compared with the contact angles of water on an untreated polished aluminum alloy product. FIG. 14C provides data showing the Tafel plots of the potentiodynamic polarization curves for a polished aluminum alloy product pretreated with a monolayer of a phosphorus-containing organic acid and a bilayer comprising a mixture of two phosphorus-containing organic acids (including a phosphonic acid-functionalized organic acid) and a metal cation that forms a bridge between the sublayers of the bilayer. The data are compared with the contact angles of water on an untreated polished aluminum alloy product. FIG. 14D provides data showing the corrosion current density values derived from the Tafel plots in FIG. 1.4C for a polished aluminum alloy product pretreated with a monolayer of a phosphorus-containing organic acid and a bilayer comprising a mixture of two phosphorus-containing organic acids (including a phosphonic acid-functionalized organic acid) and a metal cation that forms a bridge between the sublayers of the bilayer. The data are compared with the contact angles of water on an untreated polished aluminum alloy product.

FIG. 15 provides data showing water contact angles on a polished aluminum alloy product pretreated with multilayers comprising a mixture of two phosphorus-containing organic acids (including a phosphonic acid-functionalized organic acid) and a metal cation that forms a bridge between the sublayers of the multilayers. The data are compared with contact angles of the liquids on a monolayer of one of the phosphorus-containing organic acids and on an untreated aluminum alloy surface.

FIG. 16 provides data showing the polarization resistance values and the corrosion current density values of a polished aluminum alloy product pretreated with multilayers of a phosphorus-containing organic acid comprising a mixture of two phosphorus-containing organic acids (including a phosphonic acid-functionalized organic acid) and a metal cation that forms a bridge between the sublayers of the multilayers. The data are compared with a monolayer of one of the phosphorus-containing organic acids and an untreated polished aluminum alloy product.

FIG. 17 provides data showing contact angles of different liquids on a polished aluminum alloy product pretreated with a multilayer comprising a mixture of two phosphorus-containing organic acids (including a phosphonic acid-functionalized organic acid) and a metal cation that forms a bridge between the sublayers of the multilayers. The data are compared with contact angles of the liquids on a monolayer of one of the phosphorus-containing organic acids and on an untreated aluminum alloy surface.

FIG. 18 provides data showing the polarization resistance values and the corrosion current density values of an aluminum alloy product pretreated with multilayers of a phosphorus-containing organic acid comprising a mixture of two phosphorus-containing organic acids (including a phosphonic acid-functionalized organic acid) and a metal cation that forms a bridge between the sublayers of the multilayers. The data are compared with a monolayer of one of the phosphorus-containing organic acids and an untreated polished aluminum alloy product.

FIG. 19A provides data showing the plots of coefficient of friction with sliding distance on an aluminum alloy product pretreated with a water-based solution of a phosphorus-containing organic acid (including a phosphonic acid-functionalized organic acid) and lubricated with 0.2 gm⁻² of mineral oil with polar additives. FIG. 19B provides data showing the plots of coefficient of friction with sliding distance on an untreated aluminum alloy product lubricated with 0.2 gm⁻² of mineral oil with polar additives.

FIG. 20A provides data showing the plots of coefficient of friction with sliding distance on an aluminum alloy product pretreated with a water-based solution containing a mixture of two phosphorus-containing organic acids (including a phosphonic acid-functionalized organic acid and a hydroxyl-functionalized phosphonic acid) and lubricated with 0.3 gm⁻² of mineral oil with polar additives. FIG. 20B provides data showing the plots of coefficient of friction with sliding distance on an untreated aluminum alloy product lubricated with 0.3 gm⁻² of mineral oil with polar additives.

### DETAILED DESCRIPTION

Described herein are techniques for making aluminum alloy products, methods for pretreating aluminum alloys with small molecules, and the resultant aluminum alloy products. The techniques and methods described herein employ a process in which small molecules including phosphorus-containing organic acid functionality, such as organo-phosphonic acids, are applied to a surface of an aluminum alloy product to generate self-assembled monolayers or multilayers of the small molecules on the surface of the aluminum alloy product. Mixtures of different phosphorus-containing organic acids may be employed. At least some of the phosphorus-containing organic acids may exhibit a hydrophilic character, such as by including one or more hydrophilic functional groups. The self-assembled monolayers or multilayers of small molecules including hydrophilic functionality may advantageously allow the aluminum alloy product to have a good wettability by water and other hydrophilic substances, such as some epoxy adhesives or aqueous lubricants, but also to have a good wettahility by hydrophobic substances, such as non-polar organic lubricants. The self-assembled monolayer or multilayer of small molecules including hydrophilic functionality may also or alternatively advantageously provide compatibility with corrosion resistance treatment, such as conversion coating processes and/or compatibility with joining processes, such as adhesive joining and welding. In some cases, a self-assembled monolayer or multilayer of small molecules including hydrophilic functionality, and optionally a lubricant, can disrupt the surface tension between metal products that are stacked together, thus improving de-stacking capability. Additionally, a self-assembled monolayer or multilayer of small molecules including hydrophilic functionality, and optionally a lubricant, can reduce and/or stabilize frictional forces between, for example, a forming die and a sheet metal surface, leading to better formability with reduced earing, reduced wrinkling and tear-off rates, higher processing speeds, reduced galling, enhanced tool life, and improved surface quality in formed metal parts.

As shown in FIGS. 1A-1K, which provide schematic illustrations of a self-assembled monolayers and bilayers of phosphorus-containing organic acids on an aluminum alloy product surface, a variety of different configurations of phosphorus-containing organic acids may be employed. In some cases, a single phosphorus-containing organic acid may be used, as shown in FIGS. 1A, 1B, 1C, 1D, and 1G. In some cases, multiple different phosphorus-containing organic acids may be used, as shown in FIGS. 1E, 1F, 1H, 1I, 1J, and 1K. Although the configurations shown in FIGS. 1A-1K illustrate an ordered arrangement of molecules of the phosphorus-containing organic acids on the surface of the aluminum alloy product, such a configuration is for illustrative purposes only and is not intended to be limiting. The molecules of the phosphorus-containing organic acids may adopt any suitable configuration in the self-assembled monolayer or bilayer.

Molecules with surface-active functional groups for a binding to solid surfaces (including but not limited to carboxylic acid functions, amine functions, hydroxyl functions, silane functions, phosphonic acid functions, or phosphinic acid functions) and linear, functionalized or unfunctionalized alkyl groups comprising three or more carbon atoms, are widely known to form self-assembled monolayers on said inorganic surfaces. The formation of said self-assembled monolayers on solid surfaces is driven by the combination of Van der Wallis interactions between the alkyl groups that ensure a dense packing and sufficiently strong but dynamically reversible binding of the surface-active functional groups to the solid surface that allows for correction of binding defects. The obtained self-assembled monolayers on inorganic surfaces therefore feature a dense, homogeneous, continuous coverage of the surface with a dense packing of the molecules with a defined extended conformation and an average orientation of the molecules standing up on the surface, although varying degrees of conformational and packing disorder are possible. Molecules comprising phosphonic acid surface-active functional groups are known to be particularly advantageous for forming self-assembled monolayers on aluminum or aluminum oxide surfaces. Moreover, it is known that due to the average orientation of the molecules, any terminal functional group, that is a functional group attached to the end of the molecule opposite to the surface-active functional group, will therefore be exposed to the environment and can be used to tune the surface properties.

Example phosphorus-containing organic acids include small molecules having a phosphorus-based acidic group and an organic group or “tail group.” Example phosphorus-containing organic acids include phosphonic acids and phosphinic acids. Example phosphorus-containing organic acids include, but are not limited to, those having a formula of R—PO (OH)₂ or R—PO(OH)R, where each R is independently hydrogen, a functionalized or unfunctionalized alkyl group, a functionalized or unfunctionalized alkenyl group, a functionalized or unfunctionalized alkenyl group, or any combination of these. Optionally, a phosphorus-containing organic acid may have a formula of: X—(CR¹R²)ₙ—PO(OH)₂ or X—(CR¹R²)ₙ—PO(OH)H, where n is an integer from 3 to 30, where each R^{I} and R² is independently a hydrogen or a substituted or unsubstituted. alkyl, alkenyl, or alkenyl group, and where X is an —OH group, an —NH group, an —SH group, a —PO(OH)₂ group, a —PO (OH)H group, an —SO₃H group, a —COOH group, a trialkoxysilyl group, a vinyl group, an ethynyl group, an epoxy group, an acrylate group, a methacrylate group, or a methyl group. Optionally, any R, R¹, or R² may be functionalized with one or m.ore —OH groups, —NH₂ groups, —SH groups. —PO(OH)₂ groups, —PO(OH)H groups, —SO₃H groups, —COOH groups, trialkoxysilyl groups, vinyl groups, ethynyl groups, epoxy groups, acrylate groups, methacrylate groups, or any combination of these. In some examples, the phosphorus-containing organic acid has a formula of X—(CH2),—PO (OH)₂ or X—(CH₂)ₙ—PO (OH)₁₄. Useful small molecules include those having a molecular weight of from about 125 g/mol to about 1000 g/mol, such as less than=1000 g/mol, less than 900 g/mol, less than 800 g/mol, less than 700 g/mol, less than 600 g/mol, less than 500 g/mol, less than 400 g/mol, less than 300 g/mol, less than 200 Onol, from 125 g./mol to 200 g/mol, from 200 glinol to 225 g/mol, from 200 g/mol to 250 g/mol, from 200 g/mol to 275 g/mol, from 200 g/mol to 300 g/mol, from 200 g/mol to 325 g/mol, from 200 g/mol to 350 g/mol, from 200 g/mol to 375 g/mol, from 200 g/mol to 400 glinol, from 200 g/mol to 425 g/mol, from 200 g/mol to 450 g/mol, from 200 g/mol to 475 g/mol, from 200 g/mol to 500 g/mol, from 200 glinol to 525 g/mol, from 200 g/mol to 550 glinol, from 200 g/mol to 575 g/mol, from 200 g/mol to 600 g/mol, from 225 g/mol to 250 g/mol, from 225 g/tnol to 275 g/mol, from 225 g/mol to 300 g/mol, from 225 g/mol to 325 g/mol, from 225 g/mol to 350 g/mol, from 22.5 g/mol to 375 g/mol, from 225 g/mol to 400 g/mol, from 225 g/mol to 425 g/mol, from 225 g/mol to 450 g/mol, from 22.5 g/mol to 475 glinol, from 225 glinol to 500 g/mol, from 225 g/mol to 525 g/mol, from 225 g/mol to 550 g/mol, from 22.5 g/mol to 575 g/mol, from 225 g/mol to 600 g/mol, from 250 g/mol to 275 g/mol, from 250 g/mol to 300 g/mol, from 250 g/mol to 325 g/mol, from 250 g/mol to 350 g/mol, from 250 g/mol to 375 g/mol, from 250 g/mol to 400 g/mol, from 250 g/mol to 425 g/mol, from 250 g/mol to 450 g/mol, from 250 g/mol to 475 g/mol, from 250 g/mol to 500 g/mol, from 250 g/mol to 525 g/mol, from 250 g/mol to 550 g/mol, from 250 g/mol to 575 g/mol, from 250 g/mol to 600 g/mol, from 275 g/mol to 300 g1mo1, from 275 g/mol to 325 g/mol, from 275 g/mol to 350 g/mol, from 275 g/mol to 375 g/mol, from 275 g/moi to 400 g/mol, from 275 g/mol to 425 g/mol, from 275 g/mol to 450 g/mol, from 275 g/mol to 475 g/mol, from 275 g/mol to 500 g/mol, from 275 g/mol to 525 g/mol, from 275 g/mol to 550 Wino', from 275 g/mol to 575 g/mol, from 275 g/mol to 600 g1mo1, from 300 g/mol to 325 g/mol, from 300 g/mol to 350 g/mol, from 300 g/mol to 375 g/mol, from 300 g/mol to 400 Wino', from 300 g/mol to 425 g/mol, from 300 g/mol to 450 g/mol, from 300 g/mol to 475 g/mol, from 300 g/mol to 500 g/mol, from 300 g/mol to 525 g/mol, from 300 g/moi to 550 g/mol, from 300 g/mol to 575 g/mol. from 300 g/mol to 600 g/mol, from 325 g/mol to 350 g/mol, from 325 glrnol to 375 g/mol, from 325_{1.4}/mol to 400 g/mol, from 325 &lot to 425 g/mol, from 325 g/mol to 450_{1.4}/mol, from 325 g/mol to 475 g/mol, from 325 g/mol to 500 g/mol, from 325 g/mol to 525 g/mol, from 325 g/mol to 550 g/mol, from 325 g/mol to 575 g/mol, from 325 g/mol to 600 g/mol, from 350 g/mol to 375 g/mol, from 350 g/mol to 400 g/mol, from 350 g/mol to 425 g/mol, from 350 g/mol to 450 g/mol, from 350 g/mol to 475 g/mol, from 350 g/mol to 500 g/mol, from 350 g/mol to 525 g/mol, from 350 g/mol to 550 g/mol, from 350 g/mol to 575 g/mol, from 350 g/mol to 600 g/mol, from 375 g/mol to 400 g/mol, from 375 g/mol to 425 g/mol, from 375 g/mol to 450 g/mol, from 375 g/mol to 475 g/mol, from 375 g/mol to 500 g/mol, from 375 g/mol to 525 g/mol, from 375 g/mol to 550 g/mol, from 375 g/mol to 575 g/mol, from 375 g/mol to 600 g/mol, from 400 g/mol to 425 g/mol, from 400 g/mol to 450 g/mol, from 400 g/mol to 475 g/mol, from 400 g/mol to 500 g/mol, from 400 g/mol to 525 g/mol, from 400 g/mol to 550 g/mol, from 400 g/mol to 575 g/mol, from 400 g/mol to 600 g/mol, from 425 g/mol to 450 g/mol, from 425 g/mol to 475 g/mol, from 425 g/mol to 500 g/mol, from 425 g/mol to 525 g/mol, from 425 g/mol to 550 g/mol, from 425 g/mol to 575 g/mol, from 425 g/mol to 600 g/mol, from 450 g/mol to 475 g/mol, from 450 g/mol to 500 g/mol, from 450 g/mol to 525 g/mol, from 450 g/mol to 550 g/mol, from 450 g/mol to 575 g/mol, from 450 g/mol to 600 g/mol, from 475 g/mol to 500 g/mol, from 475 g/mol to 525 g/mol, from 475 g/mol to 550 g/mol, from 475 g/mol to 575 g/mol, from 475 g/mol to 600 g/mol, from 500 g/mol to 525 g/mol, from 500 g/mol to 550 g/mol, from 500 g/mol to 575 g/mol, from 500 g/moi to 600 g/mol, from 525 g/mol to 550 g/mol, from 525 g/mol to 575 g/mol, from 525 g/mol to 600 g/mol, from 550 g/mol to 575 g/mol, from 575 g/mol to 600 g/mol, from 600 g/mol to 700 g/mol, from 700 g/mol to 800 g/mol, from 800 g/mol to 900 g/tnol, or from 900 g/mol to 1000 g/mol.

In some cases, the phosphorus-containing acidic portion of a phosphorus-containing organic acid may be illustrated or described in an ionic or deprotonated configuration or a surface bonded configuration, such as where a —PO(OH)₂ group is described or illustrated as a —PO₃²⁻ group or —PO₂(OH)⁻ group or where a —PO(OH)₂ group is described or illustrated as a —PO₃ group or —PO₂(01) group with one or more bonds to a surface, or where a —PO(OH)H group is described or illustrated as a —PO₂H⁻ group or where a —PO (OH)H group is described or illustrated as a —PO₂H group with one or more bonds to a surface. Without limitation, such configurations are intended to illustrate arrangements of phosphorus-containing acidic portions of phosphorus-containing organic acids as bonded to or interacting with a surface, such as a surface of an aluminum alloy product, or with an oxide layer or hydroxyl groups present on the surface. In general, the affinity for phosphorus-containing acids to form strong bonds with aluminum surfaces will be appreciated by those skilled in the art.

Advantageously, the aluminum alloy products with self-assembled monolayers or muitilayers of phosphorus-containing organic acids described herein may be compatible with use of lubricants, which allow for good forming behavior of the aluminum alloy products and reduced susceptibility to friction-based damage during forming. For example, a lubricant, such as a mineral oil with or without additives, a corrosion protection oil, or a hot melt/wax, may be applied to the surface of an aluminum alloy product having a self-assembled monolayer or multilayer of a phosphorus-containing organic acid. Surprisingly, both water and organic lubricants may exhibit low contact angles (eg., less than or about 90°, less than or about 60°, less than or about 45°, or less than or about 20°, in some cases) with the self-assembled monolayer or multilayer including hydrophilic functional groups. In some cases, contact angles may be up to or about 110″.

Surfaces coated with phosphorus-containing organic acids with hydrophilic functional groups may be anticipated to exhibit high wettability((e.g., low contact angle) for water or other polar molecules, due to the expected strong interaction between the hydrophilic functional groups and water or other polar molecules. However, the surfaces coated with phosphorus-containing organic acids with hydrophilic functional groups as described herein exhibit high wettability for both polar and non-polar molecules. Without wishing to be bound by any theory, the inclusion of hydrophilic functional groups may increase the surface energy as compared to phosphorus-containing organic acids with only aliphatic functionality (i.e., lacking hydrophilic functional groups), and this increased surface energy may provide for better wettability. By increasing the surface energy, such as by including hydrophilic functional groups, the surface wettability will increase, independent of the hydrophobic or hydrophilic nature of the liquid.

FIG. 2 provides a schematic illustration of an example aluminum alloy product 200 with a self-assembled monolayer or multilayer 205. A drop of water 210 and a drop of lubricating oil 215 are shown on the surface. An example contact angle 220 for water 210 is shown in FIG. 2, and is about 70°. An example contact angle 225 for lubricating oil 215 is shown in FIG. 2, and is about 45°. The contact angle for different liquids may be modified by various aspects of the self-assembled monolayer or multilayer 205, such as by a coverage fraction or percentage of the surface covered by the phosphorus-containing organic acids, the identity or chemical makeup of the phosphorus-containing organic acids, the presence of one or more hydrophilic groups on the phosphorus-containing organic acids, relative amounts of different phosphorus-containing organic acids, or the like.

The self-assembled monolayer or multilayer of the disclosed phosphorus-containing organic acids, such as a hydrophilic-functionalized phosphorus-containing organic acid, may cover an entirety of a surface or may only partially cover a surface. Stated another way, coverage of the surface by the disclosed phosphorus-containing organic acids may be complete or partial. Different regions of the surface may have different coverage by the self-assembled monolayer or multi layer of the disclosed phosphorus-containing organic acids. For example, coverage of the surface by the disclosed phosphorus-containing organic acids may be complete in some regions of the surface and partial or not present in other regions of the surface. Example loadings of the disclosed phosphorus-containing organic acids may be from 0.001 mg/m² to 200 mem⁻² of phosphorus content.

Lubricants may thus wet the surface and spread into a thin layer, which may be useful for reducing friction with equipment used to form the aluminum alloy product, for example. In some cases, a smaller amount of lubricant may be needed for a suitable forming operation for aluminum alloy products having the self-assembled monolayer or multilayer as described herein than for a forming operation for aluminum alloy products lacking the self-assembled monolayer or multilayer as described herein. Further, the use of the disclosed self-assembled monolayers or multilayers of a hydrophilic-functionalized phosphorus-containing organic acid may allow for forming an aluminum alloy product with reduced defects as compared to forming an aluminum alloy product lacking the self-assembled monolayer or multilayer as described herein, in some cases.

The aluminum alloy products with disclosed self-assembled monolayers or multilayers of hydrophilic-functionalized phosphorus-containing organic acids may also or alternatively be compatible with joining to other products, such as by welding or by using adhesives like epoxy adhesives, which allow for good bond durability behavior when joined to other products. In some cases, adhesives may bond directly with the disclosed self-assembled monolayer or multilayer, such as via a chemical reaction. In some cases, the bond between the adhesive and the disclosed self-assembled monolayer may be stronger than a bond between the adhesive and an aluminum alloy product lacking the phosphorus-containing organic acid self-assembled monolayers or multilayers described herein.

Advantageously, the aluminum alloy products with self-assembled monolayers or multilayers of hydrophilic-function.alized phosphorus-containing organic acids may be compatible with use of conversion coatings, allowing good corrosion resistant behavior. That is, aluminum alloy products with self-assembled monolayers or multilayers of hydrophilic-functionalized phosphorus-containing organic acids may he subjected to conversion coating processes to create conversion coatings over a surface of the aluminum alloy products. Example conversion coatings include, but are not limited to, an anodized coating, a chromate conversion coating, a phosphate conversion coating, a titanium conversion coating, a zirconium conversion coating, and rare earth metal conversion coatings. In some cases, a chemical conversion may be achieved by an ion bound to phosphorus-containing organic acid on a surface of an aluminum alloy product, such as when the phosphorus-containing organic acid comprises an ionic group as a tail group, such as a phosphonato group (—PO₃²) or a hydrogen phosphonato group (—PO₃H). Optionally a coating may comprise a phosphorus containing organic acid having a formula of: X—(CR¹R²)ₙPO(OH)₂ or X—(CR¹R²)ₙPO(OH)H, where n is an integer from 3 to 30, where each R¹ and R² is independently a hydrogen or a substituted or unsubstituted alkyl, alkenyl, or alkynyl group, and where X is a —PO₃M group (e.g., —PO₃²⁻M²⁺ group), —PO3M1M2 group (e.g., —PO₃²⁻M1⁺M2⁺group), a —PO₃HM group (e.g., —PO₃H⁻M⁺ group), a —PO₂(OH)M (e.g., —PO₂(OH)⁻M⁺ group), where M, M1, and M2 represents a metal atom, such as Ti, Zr, Mo, Na, K, Mg, Ca, Zn, Cr, etc., or a rare earth metal atom, such as Ce, Y, Tb, La, etc.

In some cases, the formation of a self-assembled monolayer, bilayer, or multilayer on an aluminum surface, can combine multiple different functions of a coating, such that the coating becomes multifunctional. The coating functions that can be combined include, but are not limited to, improved wettability for a lubricant, decreased friction, improved corrosion resistance behavior, and improved compatibility with joining to other products, such as by welding or by using adhesives like epoxy adhesives.

### Definitions and Descriptions:

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by AA numbers and other related designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than about 15 mm, greater than about 20° C., mm, greater than about 25 mm, greater than about 30 mm, greater than about 35 mm, greater than about 40 mm, greater than about 45 mm, greater than about 50 mm, or greater than about 100 mm.

As used herein, a shie: (also referred to as a sheet plate) generally has a thickness of from about 4 mm to about 15 mm. For example, a shale may have a thickness of about 4 ram, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm).

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the meaning of “room temperature” can include a temperature of from about 15° C. to about 30° C., for example about 15 about 16° C., about 17° C., about 18°C., about 19° C., about 20° C., about 21° C., about 22° C., about 23° C., about 24° C., about 25° C, about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 31%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%; about 97%, about 98%, about 99%, about 100%, or anywhere in between. For example, barometric pressure can be about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

As used herein, the meaning of “a,” “an,” and “the” includes singular and plural references unless the context clearly dictates otherwise.

As used herein, the phrases “good wettability” and “highly wettable” refer to a condition where a contact angle of a liquid droplet on a surface is less than or about 90°, less than or about 60⁰, less than or about 50°, or less than or about 45°, In some cases, good wettability may refer to the contact angle being less than or about 30°, less than or about 20°, less than or about 15°, less than or about 10°, or less than or about 5°. In some cases, highly wettable surfaces may be referred to as hydrophilic if the surface has good wettability for water or other polar protic solvents, In some cases, highly wettable surfaces may be referred to as oleophilic or lipohilic if the surface has good wettability for organics or other non-polar solvents, such as hydrocarbons, organic solvents, oils, or the like.

As used herein, the phrase “phosphorus-containing organic acid” refers to a class of organophosphorus compounds containing —OH groups bonded to a phosphorus atom that can be deprotonated in sufficiently basic aqueous solutions. Example phosphorus-containing organic acids include, but are not limited to, phosphoric acids, phosphoric acid esters, phosphinic acids, phosphinic acid esters, or the like. Phosphorus-containing organic acids may include a phosphorus-containing group, such as a group containing a phosphate or a phosphonate, and an organic group, such as a group containing an aliphatic group or hydrocarbyl group, which may be branched or unbranched and substituted or unsubstituted and may be characterized by any suitable number of single, double, or triple carbon-carbon bonds. Example organic groups may include those comprising an alkyl chain, an alkenyl chain, or alkynyl chain, such as including from 3 to 30 carbon atoms. Organic groups may optionally include one or more non-hydrogen substituents, such as —F, —Cl, —Br, —I, —Si(O-alkyl), (trialkoxysilyl groups), —OH groups (hydroxyl groups or alcohol groups), —SH groups (sulfhydryl group or thiol groups), —NH₂ groups (amino groups), —COON groups (carboxyl groups),—PO (OH)₂ groups (phosphonate groups or phosphonic acid groups), —PO (OH)H groups (phosphinate groups or phosphinic acid groups), —SO₃H groups (sulfo groups or sulfonic acid groups), —CH═CH₂ groups (vinyl groups), —CH₂═CHCO₂ groups (acrylate groups), —C≡CH groups (ethynyl groups), epoxy groups, etc., which may in turn include one or more non-hydrogen substituents.

Organic groups may also include salt substituents or ionic substituents, which may include one or more metal atoms in place of a hydrogen atom. For example, a salt substituent may include a —PO₃M group (e.g., —PO₃²⁻M²⁺ group), —PO₃M1M2 group (e.g., —PO₃²⁻M1⁺M2⁺ group), a —PO₃₁HM group (e.g., —PO₃H⁻M²⁺ group), a —PO₂(OH)₁Lll (e.g., —PO₂(OH)⁻M⁺ group), where M, M1, and M2 represents a metal atom, such as Ti, Zr, Mo, Na, K, Mg, Ca, Zn, Cr, etc., or a rare earth metal atom, such as Ce, Y, Tb, La, etc.

In some cases, a salt substituent or an ionic substituent may serve as a bridge group for forming bi- or muitilayers of phosphorus containing acids on a surface. In one example, a bi-layer of phosphorus containing organic acids may comprise one phosphorus containing organic acid bonded to a hi-phosphorus containing acid molecule or bis-phosphorus containing organic acid molecule that is bonded to the surface, such as a molecule including phosphonic acid groups on opposite ends, linked by a functionalized or unfunctionalized organic group between the phosphonic acid groups. An example of such a bi-phosphorus containing acid molecule may comprise M₂PO₃—(CR¹R²)ₙPO₃M₂ or MPO₃—(CR¹R²)ₙ—PO₃M, where each M is independently a metal atom and may he monovalent, divalent, trivalent, etc., or M can he hydrogen, n is from 3 to 30, and R¹ and R² are independently hydrogen, a functionalized or unfunctionalized alkyl group, a functionalized or unfunctionalized alkenyl group, or a functionalized or unfunctionalized alkynyl group, optionally functionalized with one or more —OH groups, —NH₂ groups, or —SH groups. Use of Ti, Zr, Mo, Ca, or other metals as the counter-ion in the phosphorus containing organic acid moiety may allow additional phosphorus containing organic acid molecules to bond in a hi-layer type structure on an aluminum alloy product's surface, such as a structure of: aluminum alloy product surface—PO₃²⁻—(CR¹R²)ₙ—PO₃—Zr—PO₃—(CR³R⁴)ₘ—X, where m is from 3 to 30, R³ and R⁴ are independently hydrogen, a functionalized or unfunctionalized alkyl group, a functionalized or unfunctionalized alkenyl group, or a functionalized or unfunctionalized alkynyl group, and X is an —OH group, —NH₂ group, —SH group, or —PO₃H₂. FIGS. 1G-1I also show this configuration.

A “hydrophilic functional group” as used herein refers to a component of a molecule including portions that favorably interact with water molecules. Example hydrophilic functional groups may exhibit charge-polarization, such as of an extent to allow for hydrogen bonding to occur with water molecules. Example hydrophilic functional groups may include —OH groups (hydroxyl groups or alcohol groups), —SH groups (sulfhydryl group or thiol groups), —NH₂ groups (amino groups), —SO₃H groups (sulfo groups), —COOH groups (carboxyl groups), or epoxy groups. In some cases, secondary —PO(OH)₂ groups (phosphonate groups or phosphoric acid groups) or —PO(OH)H groups (phosphinate groups or phosphinic acid groups) included in the molecules described herein may provide hydrophilic functionality.

Optionally, the hydrophilic-functionalized phosphorus-containing organic acids described herein exclude hydroxyl (—OH) groups, Optionally, the hydrophilic-functionalized phosphorus-containing organic acids described herein exclude thiol (—SH) groups. Optionally, the hydrophilic-functionalized phosphorus-containing organic acids described herein exclude amino (—NH₂) groups. Optionally, the hydrophilic-functionalized phosphorus-containing organic acids described herein exclude carboxylic acid (—COOH) groups. Optionally, the hydrophilic-functionalized phosphorus-containing organic acids described herein exclude sulfo (—SO₃H) groups. Optionally, the hydrophilic-functionalized phosphorus-containing organic acids described herein exclude epoxy groups.

### Methods of Producing the Aluminum Alloy Products

The aluminum alloy products described herein can be cast and processed using any suitable techniques. For example, an aluminum alloy product may be cast using any suitable casting process. As a few non-limiting examples, the casting process can include a direct chill (DC) casting process or a continuous casting (CC) process. The continuous casting system can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

In some cases, the cast product can include a clad layer attached to a core layer as a cladded product by any suitable means. For example, a clad layer can be attached to a core layer by direct chill co-casting (i.e., fusion casting) as described in, for example, U.S. Pat. Nos. 7,748,434 and 8,927,113, both of which are hereby incorporated by reference in their entireties; by hot and cold rolling a composite cast ingot as described in U.S. Pat. No. 7,472,740, which is hereby incorporated by reference in its entirety; or by roll bonding to achieve metallurgical bonding between the core and the cladding. The initial dimensions and final dimensions of the clad aluminum alloy products described herein can be determined by the desired properties of the overall final product.

A cast ingot, cast slab, or other cast product can be processed by any suitable means. Such processing steps include, but are not limited to, homogenization, hot rolling, cold rolling, solution heat treatment, and an optional pre-aging step.

In a homogenization step, a cast product is heated to a homogenization temperature. In some examples, the homogenization temperature ranges from about 400° C. to about 500° C., although other suitable temperatures can be used. For example, the cast product can be heated to a temperature of about 400° C., about 410° C., about 420° C., about 430° C., about 440° C., about 450° C., about 460° C., about 470° C., about 480° C., about 490° C., or about 500° C. The product is then allowed to soak (i.e., held at the indicated temperature) for a period of time to create a homogenized product. In some examples, the total time for the homogenization step, including the heating and soaking phases, can be up to 24 hours. For example, the product can be heated up to 500° C. and soaked, for a total time of up to 18 hours for the homogenization step. Optionally, the product can be heated to below 490° C. and soaked, for a total time of greater than 18 hours for the homogenization step. In sonic cases, the homogenization step comprises multiple processes. In some non-limiting examples, the homogenization step includes heating a cast product to a first temperature for a first period of time followed by heating to a second temperature for a second period of time. For example, a cast product can be heated to about 465° C. for about 3.5 hours and then heated to about 480° C. for about 6 hours.

Following a homogenization step, a hot rolling step can be performed. In some cases, prior to the start of hot rolling, the homogenized product can be allowed to cool. For example, the homogenized product can be allowed to cool to a temperature of between 325° C. to 425° C. or from 350° C. to 400° C. The homogenized product can then be hot rolled at any suitable temperature, for example at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

Optionally, the cast product can be a continuously cast product.

Cast, homogenized, or hot-rolled products can be cold rolled using cold rolling mills into thinner products, such as a cold rolled sheet. In some cases, the cold rolled product can have a gauge between about 0.5 to 10 mm, e.g., between about 0.7 to 6.5 mm. Optionally, the cold rolled product can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. In some non-limiting examples, the cold rolling can be performed to result in a final gauge thickness that represents a gauge reduction of up to 85% (e.g., up to 10%, up to 20 up to 30%, up to 40%, up to 50%, up to 60%, up to 70%, up to 80%, or up to 85% reduction) as compared to a gauge prior to the start of cold rolling. Optionally, an interannealing step can be performed during the cold rolling step, such as where a first cold rolling process is applied, followed by an annealing process (interannealing), followed by a second cold rolling process, The interannealing step can be performed at a temperature of from about 300° C. to about 450° C. (e.g., about 310° C., about 320° C. about 330° C., about 340° C., about 350° C., about 360° C., about 370° C., about 380° C., about 390° C., about 400° C., about 410° C., about 420° C., about 430° C., about 440° C., or about 450° C.). In sonic cases, the interannealing step comprises multiple processes. In some non-limiting examples, the interannealing step includes heating the partially cold rolled product to a first temperature for a first period of time followed by heating to a second temperature for a second period of time. For example, the partially cold rolled product can be heated to about 410° C. for about 1 hour and then heated to about 330° C. for about 2 hours.

Subsequently, a cast, homogenized, or rolled product can undergo a solution heat treatment step. The solution heat treatment step can be any suitable treatment for the sheet which results in solutionizing of the soluble particles. The cast, homogenized, or rolled product can optionally be heated to a peak metal temperature (PMT) of up to 590° C. (e.g., from 400° C. to 590° C.) and soaked for a period of time at the PMT to create a hot product. For example, the cast, homogenized, or rolled product can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes). After heating and soaking, the hot product is optionally rapidly cooled at rates greater than 200° C.is to a temperature between 500 and 200° C. to create a heat-treated product. In one example, the hot product is cooled at a quench rate of above 200° C./second at temperatures between 450° C. and 200° C. Optionally, the cooling rates can be faster in other cases.

After quenching, the heat-treated product can optionally undergo a pre-aging treatment by reheating before coiling. The pre-aging treatment can be performed at any suitable temperature (e.g., from about 70° C. to about 125° C.) for a period of time (e.g., up to 6 hours). For example, the pre-aging treatment can be performed at a temperature of about 70° C., about 75° C., about 80° C., about 85° C., about 90° C. about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours, The pre-aging treatment can be carried out by passing the heat-treated product through a heating device, such as a device that emits radiant heat, convective heat, induction heat, infrared heat, or the like.

The cast products described herein can be used to make products in the form of sheets, plates, or other suitable products.

Methods of using the Disclosed Aluminum Alloy Products

The aluminum alloy products described herein can be used in automotive applications and other transportation applications, including aircraft and railway applications. For example, the disclosed aluminum alloy products can be used to prepare automotive structural parts, such as bumpers, side beams, roof beams, cross beams, pillar reinforcements (e.g., A-pillars, B-pillars, and C-pillars), inner panels, outer panels, side panels, inner hoods, outer hoods, or trunk lid panels. The aluminum alloy products and methods described herein can also be used in aircraft or railway vehicle applications, to prepare, for example, external and internal panels.

The aluminum alloy products and methods described herein can also be used in electronics applications. For example, the aluminum alloy products and methods described herein can be used to prepare housings for electronic devices, including mobile phones and tablet computers. In some examples, the aluminum alloy products can be used to prepare housings for the outer casing of mobile phones (e.g., smart phones), tablet bottom chassis, and other portable electronics.

The aluminum alloy products and methods described herein can be used in any other desired application.

Methods qf Pretreating Aluminum Alloy products

Described herein are methods of pretreating aluminum alloy products, and the resultant pretreated aluminum alloy products. In some examples, the metals for use in the methods described herein include aluminum alloys, for example, lxxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys. In some examples, the materials for use in the methods described herein include non-ferrous materials, including aluminum, aluminum alloys, magnesium, magnesium-based materials, magnesium alloys, magnesium composites, titanium, titanium-based materials, titanium alloys, copper, copper-based materials, composites, sheets used in composites, or any other suitable metal, non-metal or combination of materials. Monolithic as well as non-monolithic, such as roll-bonded materials, cladded alloys, clad layers, composite materials, such as but not limited to carbon fiber-containing materials, or various other materials are also useful with the methods described herein. In some examples, aluminum alloys containing iron are useful with the methods described herein. Specific example materials include 5xxx series aluminum alloys, 6xxx series aluminum alloys, or 7xxx series aluminum alloys, or aluminum alloys ciadded with 5xxx series aluminum alloys, 4xxx series aluminum alloys, or lxxx series aluminum alloys,

By way of non-limiting example, exemplary lxxx series aluminum alloys for use in the methods described herein can include AA1100, AA1100A, AA1200, AA1200A, AA1300, AM 110, AM 120, AA1230, AA1230A, AA1235, AA1435, AM 145, AA1345, AA1445, AA1150, AA1350, AA1350A, AA1450, AA1370, AA1275, AA1185, AA1285, AA1385, AA1 1 88, AA1190, AA1290, AA1193, AA1198, or AA1199.

Non-limiting exemplary 2xxx series aluminum alloys for use in the methods described herein can include AA2001, A2002, AA2004, AA2005, AA2006, AA2007, AA2007AAA2007BAA2008, AA2009, AA2010, AA2011, AA2011A, AA211.1., AA211 IA, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series aluminum alloys for use in the methods described herein can include AA3002, AA3102, AA3003, AA3103, AA3103A, AA3103B, AA3203, AA3403, AA3004, AA3004AAA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065,

Non-limiting exemplary 4xxx series aluminum alloys for use in the methods described herein can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA41.45A, AA4046, AA4047, AA4047A, or AA4147.

Non-limiting exemplary 5xxx series aluminum alloys for use in the methods described herein can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018, AA5019, AA5019A, AA5119, AA5119AAA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050AAA5050CAA5150, AA5051, AA5051, AA5151, AA5251, AA5251A, AA5351, AA5451, AA5052, AA5252, AA5352, AA5154, AA5154, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B. AA5556C, AA5257, AA5457, AA5557, AA5657, AA5058, AA5059, AA5070, AA5180, AA5180, AA5082, AA5182, AA5083, AA5183, AA5183A, AA5283, AA5283AAA5283B, AA5383, AA5483, AA5086, AA5186, AA5087, AA5187, or AA5088.

Non-limiting exemplary 6xxx series aluminum alloys for use in the methods described herein can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA61.56, AA6060. AA61.60, AA6260, AA6360, AA6460, AA6460B, AA6560, AA6660, AA6061, AA6061A, AA6261., AA6361, AA6162, AA6262, AA6262AAA6063, AA6063A, AA6463, AA6463A, AA6763, A6963, AA6064, AA6064A, AA6065, AA6066, AA6068, AA6069, AA6070, AA6081, AA6181, AA6181 A, AA6082, AA6082AAA6182, AA6091, or AA6092.

Non-limiting exemplary 7xxx series aluminum alloys for use in the methods described herein can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149,7204, AA7249, AA7349, AA7449, AA7050, AA7050, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series aluminum alloys for use in the methods described herein can include AA8005, AA8006, AA8007, AA800S, AA8010, AA8011, AA8011, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

An aluminum alloy product can be subjected to a pretreatment process to generate a self-assembled monolayer or multilayer of one or more phosphorus-containing organic acids on the surface of the aluminum alloy product, such as a pretreatment process that takes place under ambient conditions or in a room temperature or other environment. In some embodiments, the term “pretreat” may be substituted with the word “treat” and refer to a process in which a metal product, such as an aluminum alloy product, is exposed to a solution that modifies the surface of the metal product, such as prior to exposing the metal product to other substances, e.g., as an epoxy adhesive, a coating material, a conversion coating, or the like. Pretreatments, as described herein, may advantageously modify an affinity of the surface to a subsequent treatment process, such as to modify (e.g,, increase or decrease) a bonding strength of the surface with an adhesive, to modify a wettability (e.g,, increase or decrease) of the surface to different liquids (e.g., aqueous solutions, organic lubricants, etc.), Optionally, the surface of the aluminum alloy product may be exposed to a mixture containing the phosphorus-containing organic acids in a carrier or solvent, such as a water-based solution, an alcohol-based solution, or an organic solvent-based solution. A concentration of the phosphorus-containing organic acids may be from 0.001 g/L to 10 L from 0.001 g/L to 6 g/L, from 0.003 g/L to 4 g/L, from 0.01 mM to 100 mM, from 0,02 mM to 50 mM, from 0.05 mM to 10 mM, from 0.05 mM to 0.1 mM, from 0.1 mM to 0.2 mM, from 0.2 mM to 0.5 mM, from 0.5 mM to 1 mM, from 1 mM to 2 from 2 mM to 5 mM, from 5 mM to 10 mM, from 10 mM to 20 mM, from 20 mM to 50 mM, or from 50 mM to 100 mM.

When the mixture contains multiple different phosphorus-containing organic acids, each may be present at a suitable concentration. In some cases, a molar ratio of a first phosphorus-containing organic acid in the mixture to a second phosphorus-containing organic acids in the solution is from 1:200 to 200:1. In some cases, only a single phosphorus-containing organic acid may be used.

FIG. 3A provides a schematic illustration of an aluminum alloy product 300A with a self-assembled monolayer or multilayer 305 on its surface. On top of the self-assembled monolayer or multilayer 305, a layer of a lubricant 310 is shown. FIG. 3B provides a schematic illustration of a formed aluminum alloy product 300B with the self-assembled monolayer or multilayer 305 and layer of lubricant 310. The dimensions of the aluminum alloy products 300A and 300B, self-assembled monolayer or multilayer 305, and layer of lubricant 310 in FIGS. 3A-3D are not to scale. The aluminum alloy product 300A may have any suitable thickness and may be prepared according to any suitable preparation method, such as casting, homogenizing, heat-treatment, rolling, extrusion, machining, or the like.

In some embodiments, the aluminum alloy product 300A may be an aluminum alloy sheet and have a thickness of from about 4 mm to about 0.1 mm. The self-assembled monolayer or multilayer 305 may also have any suitable thickness, which may, for example, be dictated by the molecular dimensions of the phosphorus-containing organic acids comprising the self-assembled monolayer or multilayer. The layer of lubricant 310 may also have any suitable thickness, which may, for example, be dictated by the composition of the lubricant, the composition of the phosphorus-containing organic acids, and the amount of lubricant applied. Example lubricant loadings may be up to 3 glm.², i.e., from 0 to 3 g/m². In some cases, the lubricant loading is from 0,05 g./m² to 3 g/m². The amount of lubricant required may, in turn, be a sufficient amount for reducing friction in a forming operation. In some cases, no lubricant may be applied or required (i.e., a loading of 0 g/m²) for achieving a suitable amount of friction for a forming operation.

In embodiments, an aluminum alloy product having a self-assembled monolayer or multilayer of hydrophilic-functionalized phosphorus-containing organic acids may require a smaller lubricant loading to suitably form the aluminum alloy product (e.g,, to form the aluminum alloy product without fracturing, tearing, or causing other forming defects) than a comparable aluminum alloy product of the same composition and structure but lacking the self-assembled monolayer or multilayer of hydrophilic-functionalized phosphorus-containing organic acids. Stated another way, the presence of the self-assembled monolayer or multilayer of hydrophilic-functionalized phosphorus-containing organic acids may allow for use of reduced amounts of lubricant to suitably form an aluminum alloy product in a forming operation.

The aluminum alloy product 300A may be subjected to a forming operation to change the shape of the aluminum alloy product 300A. The forming operation may be one or more of stamping, rolling, drawing, roll-forming, or the like. FIG. 3B provides a schematic illustration of a formed aluminum alloy product 30013 with the self-assembled monolayer or multilayer 305 and layer of lubricant 310.After forming, the layer of lubricant 310 may optionally be removed, such as by one or more washing processes, rinsing processes, or the like.

Prior to or after forming, an aluminum alloy product may be joined to another product, such as another aluminum alloy product, a polymer product, a plastic product, a steel product, a titanium product, a magnesium product, a composite product, a glass product, or the like. For joining an aluminum alloy product to another aluminum alloy product, welding techniques may be applied. Example welding techniques include, but are not limited to resistance spot welding, laser beam welding, arc welding, metal inert gas welding, remote laser welding, friction element welding, or resistance element welding. For joining an aluminum alloy product to another aluminum alloy product or a product comprising another material, other joining methods may be used, such as joining by using mechanical joining processes, like riveting, or by use of adhesives. Example mechanical joining methods include, but are not limited to self-piercing riveting, solid riveting, clinching, flow drill screwing, tack-setting (optionally using an adhesive), or roller hemming.

FIG. 3C provides a schematic illustration of the aluminum alloy product 300B with a self-assembled monolayer or multilayer 305 joined to a second product 315 by an adhesive 320. As illustrated, second product 315 is a formed aluminum alloy product having a self-assembled monolayer or multilayer 325, similar to aluminum alloy product 300B, though second product 315 may optionally comprise another material and may or may not include a self-assembled monolayer or multilayer. Although aluminum alloy product 300B and second product 315 are shown in formed configurations in FIG. 3C, one or both of aluminum alloy product 3003 and second product 315 may optionally be in an unformed (e.g., planar) configuration. Example adhesives useful for joining an aluminum alloy product to another product may include epoxy adhesives, acrylate adhesives, rubber-based adhesives, polyurethane-based adhesives, or the like. Advantageously, adhesive 320 may strongly bind with self-assembled monolayers or multilayers 305 and 325 and provide for a high-strength joint between aluminum alloy product 30013 and second product 315.

In some cases, a self-assembled monolayer or multilayer of some phosphorus-containing organic acids may reduce an affinity for adhesion with various adhesives, such as epoxy adhesives. For example, a self-assembled monolayer or multilayer of some phosphorus-containing organic acids that do not contain hydrophilic functionality (e.g., an unsubstituted alkyl phosphonic acid) may provide an adhesive-resistant surface to an aluminum alloy product. In some cases, portions of an aluminum alloy product may be pretreated to have a self-assembled monolayer or multilayer of a phosphorus-containing organic acid with hydrophilic functionality to allow for good interaction with an adhesive, while other portions of the aluminum alloy product may be pretreated to have a self-assembled monolayer or multilayer of another phosphorus-containing organic acid, such as with no hydrophilic functionality, to allow for poor or only limited interaction with the adhesive. in this way, portions of the aluminum alloy product may have a “non-stick,” “non-adhesive,” “anti-fouling,” or “self-cleaning” character, which may be useful for modifying a strength of a join between the aluminum alloy product and another product or for providing regions of the surface with these additional characteristics. Use of different phosphorus-containing organic acids, such as with no hydrophilic functionality, may be useful for generating surfaces with low surface energy, low surface activity, or low surface reactivity, providing non-stick, non-adhesive, anti-fouling, or self-cleaning characteristics, for example.

As an example, FIG. 3D provides a schematic illustration of an aluminum alloy product 300D joined to a second product 330, with an adhesive 335 depicted positioned between aluminum alloy product 300D and a second product 330. Aluminum alloy product 300D includes a self-assembled monolayer or multilayer with different regions having different chemical functionality. As illustrated, regions 340 correspond to self-assembled monolayer or multilayer regions of a phosphorus-containing organic acid including hydrophilic functionality and regions 345 correspond to self-assembled monolayer or multilayer regions of a phosphorus-containing organic acid including a different or no functionality, such as lacking hydrophilic functionality. As an example, the various regions 340 and 345 may exhibit any suitable lateral dimensions, such as on the order of millimeters or greater. Regions 340 and 345 may have any suitable arrangement or patterning, including regular and irregular dimensions. By using regions 340 that strongly interact with adhesive 335 and regions 345 that only weakly interact with adhesive 335, a strength of the bond between aluminum alloy product 300D and second product 330 can be controlled. In this way, joined products can be created that may fail at a target application of force or strain.

While control over a bond strength is illustrated in FIG. 3D using distinct regions of different self-assembled monolayers or multilayers, other embodiments are contemplated, such as where a single self-assembled monolayer or multilayer is used, such as a self-assembled monolayer or multilayer comprising a particular ratio of different phosphorus-containing organic acids. In some examples, the relative fractional amounts of phosphorus-containing organic acids including hydrophilic functionality / phosphorus-containing organic acids including different functionality (e.g., lacking hydrophilic functionality) in a self-assembled monolayer or multilayer may be used to control bond strength. For example, a bond strength may be controlled by including a particular fractional amount of some phosphorus-containing organic acids including no hydrophilic functionality in a self-assembled monolayer or multilayer, such as less than 20% (by mass percent or by mole percent), such as from 0.01% to 20%, from 1% to 15%, from 2% to 10%, from 3% to 8%, from 4% to 6%, from 0% to 1%, from 1% to 2%, from 2% to 3%, from 3% to 4%, from 4% to 5%, from 5% to 6%, from 6% to 7%, from 7% to 8%, from 8% to 9%, from 9% to 10%, from 10% to 11%, from 11% to 12%, from 12% to 13%, from 13% to 14%, from 14% to 15%, from 15% to 16%, from 16% to 17%, from 17% to 18%, from 18% to 19%, or from 19% to 20%.

In some examples, the presence of the disclosed self-assembled monolayer or multilayer increases a strength, longevity, or durability of a joint between an aluminum alloy product and a second product as compared to a comparable joint between a comparable aluminum alloy product and the second product, such as a comparable aluminum alloy product having the same composition as the aluminum alloy product but lacking the disclosed self-assembled monolayer or multi layer as described herein (e.g., having a mill finish surface or other treated or pretreated surface). Stated another way, a joint between an aluminum alloy product and another product may be stronger, longer lived, or more durable when a self-assembled monolayer or multilayer as described herein is present on the surface of the aluminum alloy product than without the self-assembled monolayers or inultilayers described herein.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. During the studies described in the following examples, conventional procedures were followed, unless otherwise stated. Some of the procedures are described below for illustrative purposes.

### EXAMPLE 1

Smooth aluminum oxide samples were prepared and immersed in solutions comprising various phosphorus-containing organic acids to form self-assembled monolayers on the surfaces of the aluminum oxide samples. The aluminum oxide samples were fabricated by growing a thin aluminum oxide layer on top of a polished sili_{corr} wafer substrate. The samples were immersed in solutions of isopropanol at 60° C. containing 0.2 mM of the following end-functionalized phosphonic acids for a period of up to 60 minutes. At several points, the contact angles of water with the surfaces of the samples were determined. The resulting contact angles were plotted versus the immersion time and the results are shown in FIG. 4.

| Structure | Short Name |
|---|---|
| 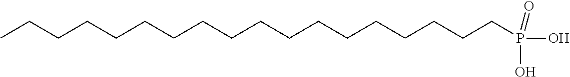 [SMILES: CCCCCCCCCCCCCCCCCCP(=O)(O)O] | C18PA |
| 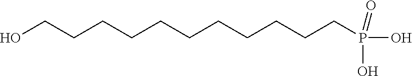 [SMILES: O=P(O)(O)CCCCCCCCCCCO] | HO-C11PA |
| 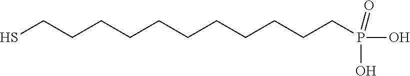 [SMILES: O=P(O)(O)CCCCCCCCCCCS] | HS-C11PA |
| 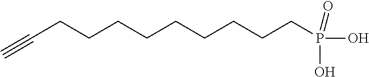 | HCC10PA |

For the thiol-functionalized HS-C11PA and the hydroxyl-functionalized HO-C11PA samples, the contact angles of water were observed to go down over time. For the HCC10PA and C18PA samples, the contact angles were observed to not change significantly. This appeared to indicate that the samples exposed to the amino-functionalized HS-C11PA and the hydroxyl-functionalized HO-C11PA became more hydrophilic and/or less hydrophobic. Not to be bound by theory, this may be due to a more complete self-assembled monolayer forming on the surface of the samples over time.

### EXAMPLE 2

Smooth aluminum oxide samples were prepared and immersed in solutions of two different phosphonic acids in various proportions to form self-assembled monolayers on the surfaces of the aluminum oxide samples. The aluminum oxide samples were fabricated by growing a thin aluminum oxide layer on top of a polished sili_{corr} wafer substrate. The samples were immersed in solutions of isopropanol at 60° C. containing 0.2 mM total of the phosphonic acids for a period of 60 minutes. The solutions used were 100% C18PA/0% HO-C11PA in isopropanol, 80% C18PA/20% HO-C11PA in isopropanol, 50% C18PA/50% HO-C11PA in isopropanol, 20% C18PA/80% HO-C11PA in isopropanol, and 0% C18PA/100% HO-C11PA in isopropanol. The contact angles of water with the surfaces of the samples were determined and are shown in FIG. 5A. The contact angles of a corrosion protection oil with the surfaces of the samples were determined and are shown in FIG. SB. Surprisingly, the highest wettability for both water and the corrosion protection oil were observed with the samples pretreated in=100% HO-Cl IPA in isopropanol.

### EXAMPLE 3

Aluminum alloy product samples with EDT (electric discharged texturing) surfaces were prepared and immersed in solutions of two different phosphonic acids in various proportions to form self-assembled monolayers on the surfaces of the aluminum alloy product samples. The aluminum alloy product samples comprised samples of an AA5754 aluminum alloy sheet. The samples were immersed in solutions of isopropanol at 60° C. containing 0.2 mM total of the phosphonic acids for a period of CO. The solutions used were 100% C18PA/0% HO-C11PA in isopropanol, 80% C18PA/20% HO-C11PA in isopropanol, 50% C18PA/50% HO-C11PA in isopropanol, 20% C18PA/80% HO-C11PA in isopropanol, and 0% C18PA/100% HO-C11PA in isopropanol. The contact angles of water with the surfaces of the samples were determined and are shown in FIG. 6A., The contact angles of a corrosion protection oil with the surfaces of the samples were determined and are shown in FIG. 6B. Again, the highest wettabilities for both water and the corrosion protection oil were surprisingly observed with the samples pretreated in=100% HO-C11PA in isopropanol.

### EXAMPLE 4

Aluminum alloy product samples with EDT surfaces were prepared and immersed in solutions of two different phosphonic acids in various proportions to form self-assembled monolayers on the surfaces of the aluminum alloy product samples. The aluminum alloy product samples comprised samples of an AA 5754 aluminum alloy sheet. The samples were immersed in solutions of isopropanol at 60° C. containing 0.2 mM total of the phosphonic acids for a period of 60 minutes. The solutions used were 100% C 1 SPA/0% HO-C11PA in isopropanol, 80% C18PA/20% HO-C11PA in isopropanol, 50% C18PA/50% HO-C11PA in isopropanol, 20% C18PA/80% HO-C11PA in isopropanol, and 0% C18PA/100% HO-C11PA in isopropanol. The contact angles of water, a mineral oil with polar additives, and a corrosion protection oil with the surfaces of the samples and a reference untreated (bare) EDT sample were determined and are shown in FIG. 7, The mineral oil with polar additives was observed to wet the surface better than water (i.e., exhibited a lower contact angle), but was not as wetting as the corrosion protection oil.

### EXAMPLE 5

Aluminum alloy product samples with EDT surfaces were prepared and immersed in solutions of two different phosphonic acids in various proportions to form self-assembled monolayers on the surfaces of the aluminum alloy product samples. The aluminum alloy product samples comprised samples of an AA5754 aluminum alloy sheet. The samples were immersed in solutions of isopropanol at 60° C. containing 0.2 mM total of the phosphonic acids for a period of 60 minutes. The solutions used were 100% C18PA/0% H2N-Cl₂PA isopropanol, 80% C18PA/20% H2N-Cl₂PA in isopropanol, 50% C18PA/50% H₂N-Cl₂PA in isopropanol, 20% C18PA/80% H2N-Cl₂PA in isopropanol, and 0% CIS:PA/100% H₂N-Cl₂PA in isopropanol. The contact angles of water, a mineral oil with polar additives, and a corrosion protection oil with the surfaces of the samples and a reference untreated (bare) EDT textured sample were determined and are shown in FIG. 8. The mineral oil with polar additives was observed to wet the surface better than water (i.e., exhibited a lower contact angle), but was not as wetting as the corrosion protection oil. The wettability for H₂N-Cl₂PA was observed to be comparable to the wettability for HO-C11PA, but the stability over time was better.

| Structure | Short Name |
|---|---|
| 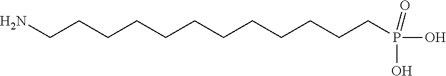 [SMILES: NCCCCCCCCCCCCP(=O)(O)O] | H₂N-C12PA |

### EXAMPLE 6

Aluminum alloy product samples with EDT surfaces were prepared and immersed in solutions of two different phosphonic acids in various proportions to form self-assembled monolayers on the surfaces of the aluminum alloy product samples. The aluminum alloy product samples comprised samples of an AA5754 aluminum alloy sheet. The samples were immersed in solutions of isopropanol at 60° C. containing 0.2 mM total of the phosphonic acids for a period of 60 minutes. The solutions used were 100% C18PA/0% HCC10PA in isopropanol, 80% C18PA/20% HCC10PA in isopropanol, 50% C18PA/50% HCC10PA in isopropanol, 20% C18PA/80% HCC10PA in isopropanol, and 0% C18PA 100% HCC10PA in isopropanol. The contact angles of water, a mineral oil with polar additives, and a corrosion protection oil with the surfaces of the samples and a reference untreated (bare) EDT textured sample were determined and are shown in FIG. 9. The mineral oil with polar additives was observed to wet the surface better than water (i.e., exhibited a lower contact angle), but was not as wetting as the corrosion protection oil. The wettability for HCCIOPA was observed to be generally less than the wettability for HO-C11PA or H₂N-Cl₂PA.

### EXAMPLE 7

Smooth aluminum oxide samples were prepared and immersed in solutions of two different phosphonic acids in various proportions to form self-assembled monolayers on the surfaces of the aluminum oxide. The samples were immersed in solutions of isopropanol at 60° C. containing a total of 0.2 mM of the acids, for varying immersion time up to 3 hours. The solutions used were 100% HO-C11PA/0% HS-C11PA in isopropanol, 80% HO-C11PA/20% HS-C11PA in isopropanol, 50% HO-C11PA/50% HS-C11PA in isopropanol, 20% HO-C11 PA/80% HS-C11PA in isopropanol, and 0% HO-C11PA/100% HS-C11PA in isopropanol. The contact angles of water with the surfaces of the samples were determined upon removal from solution after different immersion times, and shown in FIG. 10. The mixtures with a higher proportion of HO-C11PA were observed to exhibit a lower contact angle. The contact angles for HS-C11PA was observed to be generally higher than those of HO-C11PA.

### EXAMPLE 8

Aluminum alloy product samples with EDT surfaces were prepared and immersed in two solutions, one containing a single phosphonic acid and one containing a mixture of two different phosphonic acids, to form self-assembled monolayers on the surfaces of the aluminum alloy product samples. The aluminum alloy product samples comprised samples of an AA5754 aluminum alloy sheet. The samples were immersed in solutions of isopropanol at 60° C. containing 0.2 mM total of the phosphonic acids for a period of 60 minutes. The solutions used were HO-C11PA in isopropanol, and a mixture of 50% SH-C11PA/50% HO-C11PA in isopropanol. A reference untreated (bare) EDT AA5754 sample was also used for comparison. The treated samples and the reference untreated sample were subjected to bond durability testing. For example, the procedures according to FLIM BV 101-07 standard test, Stress Durability Test for Adhesive Lap-Sear Bonds (2017), which is hereby incorporated by reference, or some other standard test, may be followed.

For these tests, the aluminum alloys were cut into testing coupons, cleaned via an acid-etch procedure, and optionally coated with a coating composition as described herein. Similarly pretreated test coupons were then bonded together with a commercially available epoxy adhesive and coated with a mineral oil. Bonded test coupons were then subjected to a bond durability test wherein bonded test coupons were subjected to tension while undergoing cyclic exposure to immersion in an aqueous salt solution followed by exposure to a high humidity (e.g., at least about 75% relative humidity (RH)) and high temperature (e.g., at least about 30° C.) atmosphere. Each bonded pair is subjected to numerous cycles of these test conditions. Generally, each bonded pair is subjected to a sufficient number of cycles to reach a bond failure. In some cases, a maximum number of cycles is used, such as 60 cycles. For test conditions at 50° C. and 90% relative humidity, the reference untreated sample pairs had a bond failure as early as 10 cycles and as late as 20 cycles, with a mean failure of about 14.5 cycles. The samples exposed to HO-C11PA showed improved bonding performance, with most sample pairs exceeding 45, 55, or up to 60 cycles, although one sample pair tested showed a bond failure at 42 cycles. The samples exposed to 50% SH-C11PA/50% HO-C11PA showed further improved bonding performance, with all tested sample pairs achieving 60 cycles (the maximum tested here).

### EXAMPLE 9

Smooth aluminum oxide samples were prepared and immersed in solutions of phosphorus-containing organic acids to form self-assembled monolayers on the surfaces of the aluminum oxide. The samples were immersed in solutions of isopropanol at 60° C. containing 0.2 mM of the acids, for varying immersion times. The solutions used were HO-C11PA in isopropanol, HO-C6PA in isopropanol, PA-Cl₂PA in isopropanol, PA-C6PA in isopropanol, and PA-C4PA in isopropanol. The contact angles of water with the surfaces of the samples were determined upon removal from solution after different immersion times up to 3 hours, and shown in FIG. 11. In the case of the PA-terminated phosphonic acids, the chain length strongly influenced the magnitude of the water contact angles, where the hydrophilicity increases with decreasing chain length from Cl₂ to C4. On the other hand, for the HO-terminated phosphonic acids, the chain length did not have a major influence on the magnitude of the water contact angles, showing similar hydrophilic contact angles of 40° to 45° even though the chain length was varied between C11 and C6.

| Structure | Short Name |
|---|---|
| 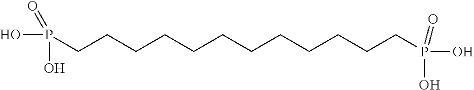 [SMILES: O=P(O)(O)CCCCCCCCCCCCP(=O)(O)O] | PA-C12PA |
| 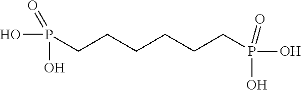 [SMILES: O=P(O)(O)CCCCCCP(=O)(O)O] | PA-C6PA |
| 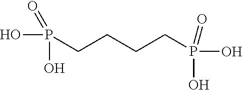 [SMILES: O=P(O)(O)CCCCP(=O)(O)O] | PA-C4PA |
| 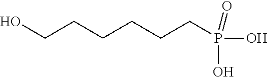 [SMILES: O=P(O)(O)CCCCCCO] | HO-C6PA |

### EXAMPLE 10

Aluminum alloy product samples with EDT surfaces were prepared and immersed in solutions of two different phosphonic acids in various proportions to form self-assembled monolayers on the surfaces of the aluminum alloy product samples. The aluminum alloy product samples comprised samples of an AA 5754 aluminum alloy sheet. The samples were immersed in solutions of isopropanol at 60° C. containing 0.2 mM total of the phosphonic acids for a period of 60 minutes. The solutions used were PA-C6PA in isopropanol, PA-C6PA in isopropanol, and a 50%/50% mixture of PA-C6PA/OH-C6PA in isopropanol. The contact angles of water with the surfaces of the samples and a reference untreated (bare) EDT textured sample were determined, and shown in FIG. 12. The water contact angle was about 90° for the reference untreated sample, about 50° for the PA-C6-PA treated sample, and about 40° for the PA-C4PA and PA-C6PA/OH-COPA treated samples.

### EXAMPLE 11

Smooth aluminum oxide samples were prepared and immersed in a solution of a phosphorus-containing organic acid to form self-assembled monolayers on the aluminum oxide surfaces. The aluminum oxide samples were immersed in a solution of water containing 0.2 mM of the acids at either 60° C. or 80° C. for varying immersion times from 1 minute up to 60 minutes. The solution used was PA-C6PA in water. Upon removal from solution, the samples were dried under a flow of argon gas. X-ray photoemission spectroscopy (XPS) was used to measure the carbon and phosphorus content of the treated aluminum oxide samples, by recording the C 1s spectra and P 2s spectra of the surfaces, respectively. The C 1 s spectra and P 2s spectra for the 60° C. solutions for immersion times of 1 minute to 60 minutes are shown in FIG. 13A, and the C 1s spectra and P 2s spectra for the 80° C. solutions for immersion times of 1 minute to 60 minutes are shown in FIG. 13B. The maximum intensities of the peak heights at binding energy of about 285 eV for the C is spectra and binding energy of about 191 eV for the P 2s spectra, for samples immersed for different times in the 60° C. and 80° C. solutions are shown in FIG. 13C and FIG. 13D, respectively. For the same immersion times, the samples immersed in the 80° C. solution showed a higher carbon and phosphorus content (based on the higher C 1s and P 2s peak intensities) than the samples immersed in the 60° C. solution. In addition, the C is and P 2s peak intensities for the sample immersed in the 80° C. solution for 15 minutes are similar to the C 1s and P 2s peak intensities for the sample immersed in the 60° C. solution for 60 minutes. This shows that the self-assembly of PA-C6PA. on the aluminum oxide surface is more rapid when the solution temperature is increased from 60° C. to 80° C., and that the time for self-assembly of PA-C6PA on the aluminum oxide surface can be reduced from 60 minutes to 1.5 minutes with the increase in solution temperature from 60° C. to 80° C.

### EXAMPLE 12

Aluminum alloy product samples that were polished down to a mirror finish with 1 μm size diamond particle slurry were prepared and subjected to two different pretreatments of phosphorus-containing organic acids to form self-assembled monolayers on the aluminum alloy product samples. The aluminum alloy product samples comprised samples of an AA5754 aluminum alloy sheet.

In one pretreatment, the polished aluminum alloy product samples were immersed in a solution of isopropanol at 60° C. containing 0.2 rriM of C18PA for a period of 10 minutes. Upon removal from solution, the pretreated polished aluminum alloy product samples were dried under a flow of argon gas and then placed in an oven at 105° C. for a period of 60 minutes (oven drying). This process treats the polished aluminum alloy product surface with a monolayer of C18PA.

In another pretreatment, the polished aluminum alloy product samples were immersed in a solution of water at 60° C. containing 0.2 mM of PAC6PA. for a period of 60 minutes. The samples were then removed from the solution, briefly rinsed with de-ionised water, and then immersed in a solution of water at 25° C. containing 5 mM of zirconyl chloride (ZrOCl₂) for a period of 30 minutes. The samples were then removed from the solution of ZrOCl₂, briefly, rinsed again with de-ionised water, and then immersed in a solution of isopropanol at 60° C. containing 0.2 mM of C18PA for a period of 10 minutes, Upon removal from solution, the pretreated polished aluminum alloy product samples were dried under a flow of argon gas and then placed in an oven at 105° C. for a period of 60 minutes (oven drying). This process treats the polished aluminum alloy product surface with a bilayer of PAC6PA—Zr-C18PA.

The contact angles of water with the surfaces of the oven-dried monolayer C18PA and bilayer PAC6PA—Zr-C18PA pretreated samples and an untreated (bare) polished aluminum alloy reference sample were determined and are shown in FIG. 14A. The monolayer C18PA pretreated sample was observed to have a higher contact angle than the bilayer PAC6PA—Zr—C18PA pretreated sample), whereas both the monolayer C18PA and bilayer PAC6PA—Zr-C18PA pretreated samples showed higher contact angles than the bare polished aluminum alloy reference sample. The hydrophobic nature of the aluminum alloy product sample after the pretreatments is expected and results from the hydrophobic methyl-termination of the C1. SPA phosphoric: acid after pretreatment, in both the monolayer and bilayer pretreated samples. However, the slightly decreased contact angle for the bilayer PAC6PA—Zr-C18 PA pretreated sample can be attributed to a higher degree of disorder within the CISPA layer of the bilayer, as compared to a CI SPA monolayer.

The oven-dried monolayer C1 SPA and bilayer PAC6PA—Zr—C MA pretreated samples and the untreated (bare) polished aluminum alloy reference sample were subjected to electrochemical corrosion testing to determine the corrosion protection efficiency of the monolayer and bilayer pretreatments on the polished aluminum alloy samples. The samples were connected to a three-electrode electrochemical cell setup, whereby the samples were connected to the working electrode, the reference electrode used was silver/silver chloride (Ag/AgCl) in 3.5 M of potassium chloride (KCl), and the counter electrode used was gold. All three electrodes were immersed in an aqueous solution of 0.1 M sodium sulfate (Na₂SO₄) as the electrolyte. A surface area of 0.38 cm² of the bare and pretreated polished aluminum alloy product samples was exposed throughout the electrochemical testing. Upon setting up the electrochemical cell and prior to performing the electrochemical corrosion tests, the samples were left to equilibrate in this environment for at least 10 minutes to determine the open circuit potential (OCP) where the current flowing through the cell is zero.

The polarization resistance (Rp) values of the samples were measured by sweeping the potential of the cell ±10 mV with respect to the OCP and measuring the current. The Rp is determined by the slope of the change in the applied potential to the change in measured current. The Rp values for the bare, monolayer C18 PA pretreated and bilayer PAC6PA—Zr-C18 PA pretreated polished aluminum alloy product samples are shown in FIG. 14B. In general, a higher Rp value suggests a better resistance of the sample to corrosion. In this case, the monolayer C18PA pretreated sample showed higher Rp (i.e., improved corrosion resistance) as compared to the bare sample. The bilayer PAC6PA—Zr-C18 PA pretreated sample demonstrated an even significantly higher Rp of more than four times that of the bare sample and more than three times that of the monolayer C18PA pretreated sample, indicating its significantly improved corrosion resistance to both the bare and monolayer pretreated samples.

Potentiodynamic polarization curves of the samples were measured by sweeping; the potential of the cell from −0.1 V to +0.2 V with respect to the OCP and measuring the corrosion current. The curves for the three samples are plotted in a semi-logarithmic Tafel plot, as shown in FIG. 14C. The potentials where the curves experience a minimum current, indicated with the arrows, correspond to the corrosion potentials of each sample. It can be seen that the corrosion potential of the bilayer PAC6PA—Zr-C18PA pretreated polished aluminum alloy product sample of about −0.12 V is significantly less negative than the corrosion potentials of the bare polished aluminum alloy product sample of about −0.47 V, and the monolayer C18 PA pretreated polished aluminum alloy product sample of about −0.43 V. In most cases, a more negative corrosion potential indicates a higher tendency of the sample to undergo corrosion by oxidation under the same conditions.

The corrosion current densities i_{corr}, which are indicative of the corrosion rate of the samples, can be calculated from the Rp values and the Tafel plots in FIG. 14C, using the Stearn-Geary Equation:

$${R}_{p} = \frac{{β}_{a} {β}_{c}}{2.3 {i}_{corr} ( {β}_{a} + {β}_{c} )}$$

where βₐ and β_{c} are the anodic and cathodic Tafel constants, respectively, which can be determined from the slopes of the anodic and cathodic Tafel plots in FIG. 14C. The i_{corr}, values of the bare and pretreated polished aluminum alloy product samples are shown in FIG. 14D. The monolayer C18PA pretreated polished aluminum alloy product sample exhibits a lower corrosion rate (lower i_{corr}) than the bare polished aluminum alloy product sample. Moreover, the bilayer PAC6PA—Zr-C18PA pretreated polished aluminum alloy product sample exhibited a more than five times reduction of its i_{corr}, as compared to the bare polished aluminum alloy product sample.

In summary, the higher Rp, more positive corrosion potential, and lower i:orr values of the bilayer PAC6PA—Zr-C18PA pretreated polished aluminum alloy product sample demonstrate the effectiveness of the bilayer PAC6PA—Zr-C18PA pretreatment in improving the corrosion resistance and reducing the corrosion rate f©r aluminum, or in this example, AA5754 aluminum alloy.

### EXAMPLE 13

Aluminum alloy samples with EDT surfaces were prepared and immersed successively in solutions of phosphoric acids and zirconium, to form self-assembled multilayers on the surfaces of the aluminum alloy product samples. The aluminum alloy product samples comprised samples of an AA5754 aluminum alloy sheet. The samples were immersed in a solution of isopropanol at 60° C. containing 0.2 mM of PAC6PA for a period of 60 minutes. The samples were then removed from the solution, briefly rinsed with isopropanol, and then immersed in a solution of ethanol at 25° C. containing 5 mM of zirconyl acetylacetonate (Zr(acac)₄) for a period of 60 minutes, before being rinsed with ethanol. These two steps were repeated to successively increase the number of layers and thus produce polished aluminum alloy product samples pretreated with (PAC6PA—Zr)ₙ multilayers, with different n=1-9. A final terminating layer was applied by immersing the sample in a solution of isopropanol at 60° C. containing 0.2 mM of C18PA for a period of 60 minutes. Upon removal from solution, the pretreated polished aluminum alloy product samples were dried under a flow of argon gas. This process thus furnishes polished aluminum alloy product samples pretreated with (PAC6PA—Zr)ₙ— C18PA multilayers, with different n=1-9.

The contact angles of water with the surfaces of the oven-dried polished aluminum alloy product samples pretreated with (PAC6PA—Zr)ₙ-C18 PA multilayers with different n=1-9, samples pretreated with a C18PA. monolayer, and an untreated EDT AA5754 sample were determined and are shown in FIG. 15. The sample pretreated with a C18 PA monolayer was observed to have a higher contact angle than the multilayer samples, whereas both the samples pretreated with a C18PA monolayer and with (PAC6PA—Zr)ₙ-C18 PA multilayers with different n=1-9 showed higher contact angles than the untreated EDT AA5754 reference sample. The hydrophobic nature of the aluminum alloy product sample after the pretreatments is expected and results from the hydrophobic methyl-termination of the C18PA phosphoric acid after pretreatment, in both the monolayer and multi layer pretreated samples. The decreased contact angle for the samples pretreated with (PAC6PA—Zr),-C1.8PA multilayers with different n=1-9 can be attributed to a slightly higher degree of disorder within the C18 PA termination layer of the multilayer samples, as compared to a C18 PA monolayer.

The polished aluminum alloy product samples pretreated (PAC6PA—Zr)ₙ-C18PA multilayers with different n=1-9, samples pretreated with a C18PA monolayer, and the untreated EDT AA5754 reference sample were subjected to electrochemical corrosion testing to determine the corrosion protection efficiency of the monolayer and multilayer pretreatments ort the aluminum alloy samples. The samples were connected to a three-electrode electrochemical cell setup, whereby the samples were connected to the working electrode, the reference electrode used was silver/silver chloride (AglAgCl) in 3.5 M of potassium chloride (KCl), and the counter electrode used was gold. All three electrodes were immersed in an aqueous solution of 0.1 M sodium sulfate (Na₂SO₄) as the electrolyte. A surface area of 0.38 cm² of the untreated EDT AA5754 product samples was exposed throughout the electrochemical testing. Upon setting up the electrochemical cell and prior to performing the electrochemical corrosion tests, the samples were left to equilibrate in this environment for at least 60 minutes to determine the open circuit potential (OCP) where the current flowing through the cell is zero.

The polarization resistance (Rp) values of the polished aluminum alloy product samples pretreated with (PAC6PA—Zr)ₙ-C18PA multilayers with different n=1-9, samples pretreated with a C18PA monolayer, and the untreated EDT AA5754 reference sample were measured by sweeping the potential of the cell ±10 mV with respect to the OCP and measuring the current. The Rp is determined by the slope of the change in the applied potential to the change in measured current. The Rp values for the untreated polished aluminum alloy product sample, the samples pretreated with a C18PA monolayer, and the samples pretreated with (PAC6PA—Zr)ₙ-C18PA multilayers with different n=1-9 are shown in FIG. 16, In general, a higher Rp value suggests a better resistance of the sample to corrosion. In this case, the sample pretreated with a C18PA. monolayer showed similar Rp (i.e,, similar corrosion resistance) as compared to the untreated polished aluminum alloy product sample. The samples pretreated with (PAC6PA—Zr)ₙ-C18PA multilayers with different n=1-9 demonstrated a significantly higher Rp (i.e., improved corrosion resistance) that successively increased with the number of layers, reaching up to 73 times higher values for the (PAC6PA—Zr)ₙ-C18PA multilayer with n=9 than the value observed for the monolayer C18PA, indicating its significantly improved corrosion resistance to both the bare and monolayer pretreated samples.

The corrosion current densities i_{corr}, are indicative of the corrosion rate of the samples. The icor, values of the polished aluminum alloy product samples pretreated with (PAC6PA—Zr)ₙ-C18PA multilayers with different n=1-9, samples pretreated with a C18PA monolayer, and the untreated EDT AA5754 reference sample are shown in FIG. 16. The sample tested with a C18PA monolayer exhibited a similar corrosion rate (only slightly lower icorr) than the bare EDT AA5754 alloy product sample. The samples pretreated with (PAC6PA—Zr)ₙ-C18PA multilayers with different n=1-9 exhibited a successive decrease in i_{corr} with increasing number of layers, reaching an up to 66-fold reduction of the i_{corr} for the sample pretreated with a (PAC6PA—Zr)ₙ-C18PA multilayers with n=9 as compared to the bare EDT AA5754 alloy product sample.

In summary, the higher Rp, the more positive corrosion potential, and the lower i_{corr} values of polished aluminum alloy product samples pretreated with multilayers (PAC6PA—Zr)ₙ-C18PA with different n=1-9 demonstrate the effectiveness of said multilayers in improving the corrosion resistance and reducing the corrosion rate for aluminum, or in this example, EDT AA5754 alloy.

### EXAMPLE 14

Aluminum alloy samples with EDT surfaces were prepared and immersed successively in solutions of phosphoric acids and zirconium, to form self-assembled multilayers on the surfaces of the aluminum alloy product samples. The aluminum alloy product samples comprised samples of an AA5754 aluminum alloy sheet. The samples were immersed in a solution of isopropanol at 60° C. containing 0.2 mM of PA.C6PA for a period of 60 minutes. The samples were then removed from the solution, briefly rinsed with isopropanol, and then immersed in a solution of ethanol at 25° C. containing 5 mM of zirconyl acetylacetonate (Zr(acac)₄) for a period of 60 minutes, before being rinsed with ethanol. These two steps were repeated to successively increase the number of layers and thus produce polished aluminum alloy product samples pretreated with (PAC6PA—Zr), multilayers, with different n=1-9. A final terminating layer was applied by immersing the sample in a solution of isopropanol at 60° C. containing 0.2 mM of HO-Cl IPA for a period of 60 minute. Upon removal from solution, the pretreated polished aluminum alloy product samples were dried under a flow of argon gas. This process thus furnishes polished aluminum alloy product samples pretreated with TAC6PA—Zr)ₙ—HO-C11PA multilayers, with different 11 =1-9.

The contact angles of water with the surfaces of the oven-dried polished aluminum alloy product samples pretreated with (PAC6PA—Zr)-HO-Cl1PA multilayers with different n=1-9, samples pretreated with a HO-C11PA monolayer, and an untreated EDT AA5754 sample were determined and are shown in FIG. 17. The sample pretreated with a HO-C11PA monolayer was observed to have a higher contact angle than the multilayer samples, whereas both the samples treated with a HO-C11PA monolayer and sample pretreated with (PAC6PA—Zr)ₙ—HO-C11PA multilayers with different n=1-9 showed higher contact angles than the untreated EDT AA5754 reference sample. The more hydrophobic nature of the aluminum alloy product sample after the pretreatments with organic compounds is expected. However, the decreased contact angle for the samples pretreated with (PAC6PA—Zr)ₙ—HO-C11PA multilayers with different n=1-9 indicates a higher hydrophilicity and hence a denser OH-termination of the HO-C11PA terminating layers in the multilayers, as compared to a HO-C11PA monolayer.

The polished aluminum alloy product samples pretreated (PAC6PA—Zr)ₙ—HO-C11PA multilayers with different n=1-9, samples pretreated with a HO-C11PA monolayer, and the untreated EDT AA5754 reference sample were subjected to electrochemical corrosion testing to determine the corrosion protection efficiency of the monolayer and multilayer pretreatments on the aluminum alloy samples. The samples were connected to a three-electrode electrochemical cell setup, whereby the samples were connected to the working electrode, the reference electrode used was silver/silver chloride (AglAgCl) in 3.5 M of potassium chloride (KCl), and the counter electrode used was gold. All three electrodes were immersed in an aqueous solution of 0.1 M sodium sulfate (Na₂SO₄) as the electrolyte, A surface area of 0.38 cm² of the untreated EDT AA5754 product samples was exposed throughout the electrochemical testing, Upon setting up the electrochemical cell and prior to performing the electrochemical corrosion tests, the samples were left to equilibrate in this environment for at least 60 minutes to determine the open circuit potential (OCP) where the current flowing through the cell is zero.

The polarization resistance (Rp) values of the polished aluminum alloy product samples pretreated with (PAC6PA—Zr)ₙ—HO-C11PA multilayers with different n=1-9, samples pretreated with a HO-C11PA monolayer, and the untreated EDT AA5754 reference sample were measured by sweeping the potential of the cell ±10 mV with respect to the OCP and measuring the current. The Rp is determined by the slope of the change in the applied potential to the change in measured current. The Rp values for the untreated polished aluminum alloy product sample, the samples pretreated with a HO-C11PA monolayer, and the samples pretreated with (PAC6PA—Zr)ₙ—HO-C11PA multilayers with different n=1-9 are shown in FIG. 18. In general, a higher Rp value suggests a better resistance of the sample to corrosion. In this case, the sample pretreated with a HO-C11PA monolayer showed similar Rp (i.e., similar corrosion resistance) as compared to the untreated polished aluminum alloy product sample. The samples pretreated with (PAC6PA—Zr)ₙ—HO-C11PA multilayers with different n=1-9 demonstrated a significantly higher Rp (i.e., improved corrosion resistance) that successively increased with the number of layers, reaching up to 16 times higher values for the (PAC6PA—Zr)ₙ—HO-C11PA multilayer with n=9 than the value observed for the monolayer HO-C11PA, indicating its significantly improved corrosion resistance to both the bare and monolayer pretreated samples.

The corrosion current densities i_{corr}, are indicative of the corrosion rate of the samples. The i_{corr} values of the polished aluminum alloy product samples pretreated with (PAC6PA—Zr)ₙ—HO-C11PA multilayers with different n=1-9, samples pretreated with a C18PA monolayer, and the untreated EDT AA5754 reference sample are shown in FIG. 18. The sample tested with a HO-C11PA monolayer exhibited a similar corrosion rate (only slightly lower i_{corr}) than the bare EDT AA5754 alloy product sample. The samples pretreated with (PAC6PA—Zr)ₙ—HO-C11PA multilayers with different n=1-9 exhibited a successive decrease in i_{corr} with increasing number of layers, reaching an up to 17-fold reduction of the icorr for the sample pretreated with a (PAC6PA—Zr)ₙ—HO-C11PA multilayers with n=9 as compared to the bare EDT AA5754 alloy product sample.

In summary, the higher Pip, the rn.ore positive corrosion potential, and the lower i_{corr} values of polished aluminum alloy product samples pretreated with multilayers (PAC6PA—Zr)ₙ—HO-C11PA with different n=1-9 demonstrate the effectiveness of said multilayers in improving the corrosion resistance and reducing the corrosion rate for aluminum, or in this example, EDT AA5754 alloy, while their HO-termination and maintained hydrophilicity are advantageous for the wetting of the suffices with a lubricant, and for their bonding performance.

### EXAMPLE 15

Aluminum alloy product samples with mill finish surfaces were prepared and immersed in a solution of containing an organic phosphonic acid, to form self-assembled monolayers on the surfaces of the aluminum alloy product samples. The aluminum alloy product samples comprised samples of an AA5754 aluminum alloy sheet. The samples were immersed in a solution of water at 60° C. containing 0.2 mi'd of the phosphonic acid for a period of 60 minutes. The solution used was PA.C6PA in water. An untreated (bare) mill finish AA5754 reference sample was also used for comparison.

The pretreated aluminum alloy product samples and the reference untreated samples were lubricated with 0.2 m⁻² of a mineral oil with polar additive using a roll-coater, and then subjected to nanotribology testing. For these tests, the lubricated samples were mounted on a sample holder in a nanotribometer, and a clean stainless-steel ball of 2 mm diameter was brought into contact with the sample surface such that a normal load of 300 mN is applied onto the sample. Tests were performed by sliding the ball across the surface back and forth in a linear reciprocating mode, with an amplitude of 4 mm per cycle and maximum sliding speed of 5

Nanotribology tests were performed for 2000 cycles, corresponding to a sliding distance of 800 cm. The friction force is measured using a capacitive sensor with high sensitivity, and converted to the coefficient of friction (COF), which is the ratio of the friction force to the applied normal load. The plots of COF with sliding distance measured at three locations on a lubricated PAC6PA pretreated mill finish AA5754 sample are shown in FIG. 19A and the plots of COF with sliding distance measured at two locations on the lubricated reference untreated mill finish AA5754 sample are shown in FIG. 19B.

It can be seen that, on average, the lubricated PAC6PA pretreated mill finish AA5754 sample sustained a longer sliding distance of low friction, of about 240 cm, before the point of failure (i.e,, when the COF jumps from a value of about 0.2 to about 0.6). In comparison, the lubricated reference untreated mill finish AA5754 sample sustained an average sliding distance of low friction of about 81 cm before the point of failure. These data indicate that the PAC6PA. self-assembled monolayer pretreatment was beneficial in enhancing the lubrication performance of a mill finish AA5754 sample coated with 0.2 gm⁻² of a mineral oil with polar additive.

### EXANIPLE, 16

Aluminum alloy samples with EDT surfaces were prepared and immersed in a solution of containing a mixture of two different phosphonic acids, to form self-assembled monolayers on the surfaces of the aluminum alloy product samples. The aluminum alloy product samples comprised samples of an AA5754 aluminum alloy sheet. The samples were immersed in a solution of water at 60° C., containing 0.2 mM total of the phosphonic acids for a period of 60 minutes. The solution used was a mixture of 50% PAC6PA 1 50% HOC6PA in water. A reference untreated (bare) EDT .AA5754 sample was also used for comparison.

The pretreated aluminum alloy product samples and the reference untreated samples were lubricated with 0.3 gm ⁻² of a mineral oil with polar additive using a roll-coater, and then subjected to nanotribology testing. For these tests, the lubricated samples were mounted on a sample holder in a nanotriborneter, and a clean stainless-steel ball of 2 mm diameter was brought into contact with the sample surface such that a normal load of 300 mN is applied onto the sample. Tests were performed by sliding the ball across the surface back and forth in a linear reciprocating mode, with an amplitude of 4 mm per cycle and maximum sliding speed of 5 mm/s. Nanotribology tests were performed for 2000 cycles, corresponding to a sliding distance of 800 cm. The friction force is measured using a capacitive sensor with high sensitivity, and converted to the coefficient of friction (COF), which is the ratio of the friction force to the applied normal load. The plots of COF with sliding distance measured at four locations on a lubricated 50% PAC6PA/50% HOC6PA pretreated EDT AA5754 sample are shown in FIG. 20A and the plots of COF with sliding distance measured at three locations on the lubricated reference untreated EDT AA5754 sample are shown in FIG. 20B.

It can be seen that, on average, the lubricated 50% PAC6PA/50% HOC6PA pretreated. EDT AA5754 sample sustained a longer sliding distance of low friction, of about 412 cm, before the point of failure (i.e., when the COF jumps from a value of about 0.2 to about 0.6). In comparison, the lubricated reference untreated EDT AA5754 sample sustained an average sliding distance of low friction of about 205 cm before the point of failure, These data indicate that the 50% PAC6PA/50% HOC6PA self-assembled monolayer pretreatment was beneficial in enhancing the lubrication performance of a EDT AA5754 sample coated with 0.3 gm⁻² of a mineral oil with polar additive.

### COMPARATIVE EXAMPLE 1

Aluminum alloy product samples with EDT surfaces were prepared and subjected to comparative surface treatments. The aluminum alloy product samples comprised samples of an AA 5754 aluminum alloy sheet, One set of samples was immersed in a solution of isopropanol at 60° C. containing 0.2 mkt total of HO-Cl IPA for a period of 60 minutes, A reference untreated (bare) EDT sample was also used. Water contact angles with the samples were monitored as a function of time. For the reference untreated sample, the water contact angle increased as the water was in contact for a period of 24 hours (about)65° to 1 week (about 75°) to 1 month (about 83°). For the samples with the self-assembled monolayer of HO-C11-PA on the surface, the water contact angle was found to be relatively constant at about 70″ for a period of up to 1 month, indicating that the surfaces with the self-assembled monolayers are much more stable than the untreated surface and the surface with conventional pretreatment.

### COMPARATIVE EXAMPLE 2

Aluminum alloy product samples were prepared and subjected to surface treatments. The aluminum alloy product samples comprised samples of an AA 5754 aluminum alloy sheet. One set of samples was immersed in a solution of isopropanol at 60° C. containing 0.2 mM total of HO-C11PA for a period of 60 minutes. A set of reference untreated (bare) EDT AA5754 samples were also used for comparison. Standard tests for measuring dynamic coefficients of friction as a function of contact pressure were performed with samples coated with a standard amount of mineral oil lubricant and with the lubricant coating weight reduced to ½ load for other samples to evaluate the impact of the surface treatment on friction. For example, the procedures according to ASTM E1911-19, Standard Test Method for Measuring Surface Frictional Properties Using the Dynamic Friction Tester, ASTM international, West Conshohocken, Pa., 2019, hereby incorporated by reference, may be followed. The reference untreated sample and the sample treated with HO-C11PA and coated with a standard amount of mineral oil lubricant were found to have nearly identical friction coefficients as one another, ranging from about 0.17 at low contact pressures of about I MPa, to about 0.05 at contact pressures of about 12 MPa. The reference untreated samples and the samples treated with HO-C11PA and coated with ½ load of mineral oil lubricant showed similar friction coefficients profiles as one another as a function of contact pressure, ranging from about 0.27 at low contact pressures of about I NIPa, to about 0.14 at contact pressures of about 12 MPa, though the reference untreated samples showed galling at pressures of 6 MPa and up, while the HO-C11PA treatment prevented galling at all contact pressures tested up to about 12 MPa

### COMPARATIVE EXAMPLE 3

Aluminum alloy product samples were prepared and subjected to surface treatments. The aluminum alloy product samples comprised samples of an AA 5754 aluminum alloy sheet. One set of samples was immersed in a solution of isopropanol at 60° C. containing 0.2 mM total of HO-C11PA for a period of 60 minutes. A set of reference untreated (bare) EDT AA5754 samples were also used for comparison. Some of the reference untreated samples were loaded with a standard amount of mineral oil lubricant, some of the reference untreated samples were loaded with a ½ lubricant load, and the HO-C11PA treated samples were loaded with a ½ lubricant load. Blanks of the samples were drawn into cups at different clamping force to evaluate the impact of the surface treatment. The cups were drawn to depths of up to about 42 mm to evaluate the depth at which cracking occurred. At a low clamping force of about 10 kN, the samples with no surface treatment and a standard lubricant loading, the samples with no surface treatment and a ½ lubricant loading, and the samples treated with HO-C11PA and a ½ lubricant loading were all able to be drawn to the full 42 mm depth without cracking observed. At a higher clamping force of about 20° C., kN, the samples with no surface treatment and a standard lubricant loading and the samples treated with HO-C11PA and a ½ lubricant loading were able to be drawn to the full 42 mm depth without cracking observed, while the samples with no surface treatment and a ½ lubricant loading were only able to be drawn to about 23 mm and remain crack free. At an even higher clamping force of about 61) kN, the samples with no surface treatment and a standard lubricant loading and the samples treated with HO-C11PA and a ½ lubricant loading were able to be drawn to only about 24 mm or 25 mm depth and remain crack-free, while the samples with no surface treatment and a ½ lubricant loading were only able to be drawn to about 20° C., mm and remain crack-free.

### COMPARATIVE EXAMPLE 4

Aluminum alloy product samples with EDT surfaces and with mill finish were prepared and subjected to comparative surface treatments. The aluminum alloy product samples comprised samples of an AA 5754 aluminum alloy sheet. Sets of samples mill finish and EDT surface were immersed in a solution of isopropanol at 60 oC containing 0.2 mM total of HO-C11PA for a period of 60 minutes. Sets of samples mill finish and EDT surface were subjected to a conventional pretreatment. Sets of samples mill finish and EDT surface were subjected to a Ti/Zr conversion coating. The Ti/Zr conversion coating was applied by a roll-coating technique, which contrasts with other techniques, like spray coating. Duplicate samples of the mill finish surface samples were loaded with a standard amount of mineral oil lubricant and with the lubricant loading reduced to ½ load. The EDT surface samples were loaded with a ⅓ lubricant load.

Standard tests for measuring dynamic coefficients of friction as a function of contact pressure were perfbrmed. For example, the procedures according to ASTM E1911-19, Standard Test Method fbr Measuring Surface Frictional Properties Using the Dynamic Friction Tester, ASTM International, West Conshohocken, Pa., 2019, hereby incorporated by reference, may be followed.

The EDT surface samples loaded with 1/3 load of mineral oil lubricant showed similar friction coefficients profiles as one another as a function of contact pressure, ranging from about 0.26 at low contact pressures of about 1 MPa, to about 0.15 at contact pressures of about 11 MPa Galling occurred for the samples with a Ti/Zr conversion coating at a contact pressure of about 11 MPa Galling occurred for the samples with a conventional pretreatment at a contact pressure of about 13 MPa The HO-C11PA treated samples did not show galling until much higher contact pressures of about 15 MPa.

The mill finish samples with a conventional pretreatment and loaded with a standard amount of lubricant exhibited a friction coefficient of about 0.18 and galling began occurring at about 6 MPa.

The mill finish samples treated with HO-CliPA and loaded with ½ load of lubricant showed galling at about 6 MPa, with a friction coefficient of about 0.21. When loaded with a standard amount of lubricant, the friction coefficient for the HO-CliPA treated samples reduced to about 0.15 at 2 MPa and rose to about 0.22 at 12 MPa, with no galling observed.

Other characteristics of the samples with the Ti/Zr conversion coating were observed. The application method used for applying the Ti/Zr conversion coating appeared to impact the wettability of the surface, despite use of the same coating weight for application of a Ti/Zr conversion coating. That is, the wettability of the surface was different whether the Ti/Zr conversion coating was applied using an immersion coating method, a roll-coating method, or a spray coating method. In addition, the surface resistance of the samples with the Ti/Zr conversion coating appeared ⁻to be higher than is typically seen for application of a Ti/Zr conversion coating using other methods, such as spray coating methods. The higher surface resistance may correlate with a thicker oxide layer. Similarly, a thicker oxide layer may correlate with a lower coefficient of friction than for a thinner oxide layer or clean metal surface. Further, for the Ti/Zr conversion coated samples with the coating applied using a roll-coating method, the water contact angle exhibited an increase over time. The increase may be correlated with evaporation of water from the surface over time. For example, if the surface was not completely dry upon initial determination of the water contact angle, the water contact angle may exhibit an artificial lowering. Additionally, if the surface was not completely dry upon performance of the friction tests, the evaporation of water over time may have resulted in a similar coefficient of friction as the other samples tested.

All patents, publications and abstracts cited above are incorporated herein by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

### Illustrative Aspects

As used below, any reference to a series of aspects (e.g., “Aspects 1-4”) or non-enumerated group of aspects (e.g., “any previous or subsequent aspect”) is to be understood as a reference to each of those aspects disjunctively (0,₁₋₄., “Aspects 1-4” is to be understood as “Aspects 1, 2, 3, or 4”).

Aspect 1 is a method comprising: providing an aluminum alloy product; applying one or more phosphorus-containing organic acids to a surface of the aluminum alloy product to generate a self-assembled monolayer or multilayer on the surface of the aluminum alloy product, wherein at least a portion of the phosphorus-containing organic acids are hydrophilic-functionalized phosphorus-containing organic acids, wherein the one or more phosphorus-containing organic acids are small molecules each having molecular weights of less than=1000 g/mol, and wherein the one or more phosphorus-containing organic acids are selected from the group consisting of hydroxyl-functionalized phosphorus-containing organic acids, amino-functionalized phosphorus-containing organic acids, and sultlydryl (thiol)-functionalized phosphorus-containing organic acids, wherein the aluminum alloy product with the self-assembled monolayer or multilayer exhibits a contact angle with a lubricant of less than 90°.

Aspect 2. is the method of any previous or subsequent aspect, further comprising: applying the lubricant to the surface of the aluminum alloy product; or wherein applying the one or more phosphorus-containing organic acids to the surface of the aluminum alloy product comprises applying, to the surface of the aluminum alloy product, a lubricant containing the one or more phosphorus-containing organic acids in a dissolved or suspended state.

Aspect 3 is the method of any previous or subsequent aspect, wherein one or more of the phosphorus-containing organic acids are phosphoric acids.

Aspect 4 is the method of any previous or subsequent aspect, wherein one or more of the phosphorus-containing organic acids have a formula of: R-PO(OH)₂, wherein R is a functionalized or unfunctionalized alkyl group, a functionalized or unfunctionalized alkynyl group, or any combination of these.

Aspect 5 is the method of any previous or subsequent aspect, wherein R is functionalized with one or more —OH groups, —NH? groups, —SH groups, —PO(OH)₂ groups, —PO(OH)H groups, —SO₃H groups, trialkoxysilyl groups, ethynyl groups, epoxy groups, acrylate groups, methacrylate groups, or any combination of these.

Aspect 6 is the method of any previous or subsequent aspect, wherein one or more of the phosphorus-containing organic acids have a formula of: X—(CR¹R²)ₙ—PO(OH)₂, wherein n is an integer from 3 to 30, wherein each R¹ and R² are independently a hydrogen, a functionalized or unfunctionalized alkyl group, a functionalized or unfunctionalized alkenyl group, or a functionalized or unfunctionalized alkynyl group, and wherein X is an —OH group, an —NH? group, or an —SH group.

Aspect 7 is the method of any previous or subsequent aspect, wherein one or more R¹ or R² are functionalized with one or more —OH groups, —NH₂ groups, —SH groups, —PO(OH)₂ groups, —PO(OH)₁₄ groups, —SO₃H groups, trialkoxysilyl groups, ethynyl groups, vinyl groups, epoxy groups, acrylate groups, methacrylate groups, or any combination of these.

Aspect 8 is the method of any previous or subsequent aspect, wherein one or more of the phosphorus-containing organic acids have a formula of: X—(CH2)ₙ—PO(OH)₂, wherein n is an integer from 3 to 30, and wherein X is an —OH group, an —NH₂ group, or an —SH group.

Aspect 9 is the method of any previous or subsequent aspect, wherein the one or more phosphorus-containing organic acids have molecular weights of less than 600 g/mol.

Aspect 10 is the method of any previous or subsequent aspect, wherein applying the one or more phosphorus-containing organic acids to the surface of the aluminum ahoy product comprises applying a mixture containing the one or more phosphorus-containing organic acids and a carrier to the surface of the aluminum ahoy product.

Aspect 11 is the method of any previous or subsequent aspect, wherein the carrier comprises one or more of water, an alcohol, or an organic sot vent.

Aspect 12 is the method of any previous or subsequent aspect, wherein a concentration of the one or more phosphorus-containing organic acids in the carrier is from 0.001 g/L to 10 g/L or from 0.01 mM to 100 mM.

Aspect 13 is the method of any previous or subsequent aspect, wherein the one or more phosphorus-containing organic acids comprise a mixture of two or more different phosphorus-containing organic acids.

Aspect 14 is the method of any previous or subsequent aspect, wherein a molar ratio of a first phosphorus-containing organic acid in the mixture to a second phosphorus-containing organic acid in the mixture is from 1:200 to 200:1.

Aspect 15 is the method of any previous or subsequent aspect, wherein a first phosphorus-containing organic acid in the mixture comprises a hydrophilic-functionalized phosphorus-containing organic acid and wherein a second phosphorus-containing organic acid in the mixture comprises a different hydrophilic-fimctionalized phosphorus-containing organic acid.

Aspect 16 is the method of any previous or subsequent aspect, wherein a first phosphorus-containing organic acid in the mixture comprises a hydrophilic-functionalized phosphorus-containing organic acid and wherein a second phosphorus-containing organic acid in the mixture comprises a phosphorus-containing organic acid lacking a hydrophilic-functional group.

Aspect 17 is the method of any previous or subsequent aspect, wherein one or more of the phosphorus-containing organic acids comprise molecules functionalized with multiple phosphorus-containing acids.

Aspect 18 is the method of any previous or subsequent aspect, wherein one or more of the phosphorus-containing organic acids comprise molecules functionalized with a phosphorus-containing acid salt including a Ti, Zr, Mo, Na, K, Mg, Ca, Zn, Cr, Ce, Y, La ion.

Aspect 19 is the method of any previous or subsequent aspect, wherein the one or more phosphorus-containing organic acids consist of or consist essentially of hydroxyl-functionalized phosphorus-containing organic acids.

Aspect 20 is the method of any previous or subsequent aspect, wherein the one or more phosphorus-containing organic acids consist of or consist essentially of amino-functionalized phosphorus-containing organic acids.

Aspect 21 is the method of any previous or subsequent aspect, wherein the one or more phosphorus-containing organic acids consist of or consist essentially of thiol-functionalized phosphorus-containing organic acids.

Aspect 22 is the method of any previous or subsequent aspect, wherein the one or more phosphorus-containing organic acids consist of or consist essentially of bis-phosphorus-containing organic acids.

Aspect 23 is the method of any previous or subsequent aspect, wherein the one or more phosphorus-containing organic acids consist of or consist essentially of any combination of hydroxyl-functionalized phosphorus-containing organic acids, amino-functionalized phosphorus-containing organic acids, thiol-functionalized phosphorus-containing organic acids, or his-phosphorus-containing organic acids.

Aspect 24 is the method of any previous or subsequent aspect, further comprising: subjecting the aluminum alloy product to a forming operation to generate a formed aluminum alloy product; and joining the formed aluminum alloy product to a second product to generate a joined product.

Aspect 25 is the method of any previous or subsequent aspect, wherein joining the formed aluminum alloy product and the second product comprises applying an adhesive between the formed aluminum alloy product and the second product.

Aspect 26 is the method of any previous or subsequent aspect, wherein the adhesive comprises an epoxy adhesive, an acrylate adhesives, a rubber-based adhesive, or a polyurethane-based adhesive.

Aspect 27 is the method of any previous or subsequent aspect, wherein applying the adhesive forms a chemical bond between the adhesive and the self-assembled monolayer or multilayer.

Aspect 28 is the method of any previous or subsequent aspect, wherein the self-assembled monolayer or multilayer increases a strength, longevity, or durability of a joint created by the joining as compared to a comparable joint between a comparable aluminum alloy product lacking the self-assembled monolayer or multilayer and the second product.

Aspect 29 is the method of any previous or subsequent aspect, wherein joining the formed aluminum alloy product the second product comprises welding the formed aluminum alloy product and the second product or mechanically joining the formed aluminum alloy product and the second product.

Aspect 30 is the method of any previous or subsequent aspect, wherein the forming operation generates less defects in the formed aluminum alloy product as compared to a comparable forming operation using a comparable aluminum alloy product lacking the self-assembled monolayer or multilayer.

Aspect 31 is the method of any previous or subsequent aspect, further comprising subjecting the joined product to a corrosive environment.

Aspect 32 is the method of any previous or subsequent aspect, further comprising generating a conversion coating on the aluminum alloy product, the formed aluminum alloy product, or the joined product.

Aspect 33 is the method of any previous or subsequent aspect, further comprising generating a chromate conversion coating or a phosphate conversion coating on the aluminum alloy product, the formed aluminum. alloy product, or the joined product.

Aspect 34 is the method of any previous or subsequent aspect, further comprising generating a titanium conversion coating, a zirconium conversion coating, or a rare earth m.etal conversion coating on the aluminum alloy product, the formed aluminum alloy product, or the joined product.

Aspect 35 is the method of any previous or subsequent aspect, wherein the second product is a second aluminum alloy product, a steel product, a magnesium product, a titanium product, a composite product, or a polymeric product.

Aspect 36 is the method of any previous or subsequent aspect, wherein the lubricant is a non-aqueous lubricant, wherein the lubricant is an aqueous lubricant, or wherein the lubricant contains the one or more phosphorus-containing organic acids in a dissolved or suspended state.

Aspect 37 is the method of any previous or subsequent aspect, wherein the lubricant comprises one or more of a mineral oil with or without additives, a corrosion protection oil, or a hot melt/wax.

Aspect 38 is the method of any previous or subsequent aspect, wherein an amount of the lubricant applied to the surface of the aluminum alloy product is from 0 to 3 glin² or from 0.05 g/m² to 3 g/m².

Aspect 39 is the method of any previous or subsequent aspect, wherein the contact angle is from 0° to 45°, from 0° to 20°, or from 0° to 10°.

Aspect 40 is the method of any previous or subsequent aspect, wherein a water contact angle with the surface of the aluminum alloy product with the self-assembled monolayer or multilayer is from 0° to 110°, from 0° to 45°, from 0° to 20°, or from 0° to 10°.

Aspect 41 is the method of any previous or subsequent aspect, wherein the aluminum alloy product is an aluminum alloy sheet.

Aspect 42 is the method of any previous or subsequent aspect, wherein the aluminum alloy product comprises a 5xxx series aluminum alloy, a 6xxx series aluminum alloy, a 7xxx series aluminum alloy, or an aluminum alloy cladded. with a 5xxx series aluminum alloy, a 4xxx series aluminum alloy, or a 1xxx series aluminum alloy,

Aspect 43 is the method of any previous or subsequent aspect, wherein the self-assembled monolayer or multilayer covers only a portion of the surface of the aluminum alloy product.

Aspect 44 is the method of any previous or subsequent aspect, wherein the self-assembled monolayer or multilayer covers an entirety of the surface of the aluminum alloy product.

Aspect 45 is a pretreated metal product, comprising: an aluminum alloy product having a surface, wherein a self-assembled monolayer or multilayer is present on the surface, the self-assembled monolayer or multilayer comprising one or more phosphorus-containing organic acids bonded to the surface, wherein at least a portion of the phosphorus-containing organic acids are hydrophilic-functionalized phosphorus-containing organic acids, wherein the one or more phosphorus-containing organic acids are small molecules each having molecular weights of less than 1000 glinol, and wherein the one or more phosphorus-containing organic acids are selected from the group consisting of hydroxyl-functionalized phosphorus-containing organic acids, amino-functionalized phosphorus-containing organic acids, and sulfhydryl (thiol)-functionalized phosphorus-containing organic acids.

Aspect 46 is the pretreated metal product of any previous or subsequent aspect, wherein one or more of the phosphorus-containing organic acids are phosphonic acids.

Aspect 47 is the pretreated metal product of any previous or subsequent aspect, wherein one or more of the phosphorus-containing organic acids have a formula of: R—PO (OH)₂, wherein R is a functionalized or unfunctionalized alkyl group, a functionalized or unfunctionalized alkynyl group, or any combination of these.

Aspect 48 is the pretreated metal product of any previous or subsequent aspect, wherein R is functionalized with one or more —OH groups, —NH₂ groups, —SH groups, —PO(OH)₂ groups, —PO(OH)H groups, —SO₃H groups, trialkoxysilyl groups, ethynyl groups, epoxy groups, acrylate groups, methacrylate groups, or any combination of these.

Aspect 49 is the pretreated metal product of any previous or subsequent aspect, wherein one or more of the phosphorus-containing organic acids have a formula of: X—(CH₂)ₙ—PO (OH)₂, wherein n is an integer from 3 to 30, and wherein X is an OH group, an —NH₂ group, an —SH group, a —PO(OH)₂ group, a —PO(OH)H group, an —SO₃H group, a vinyl group, an epoxy group, an acrylate group, a methyl group, or an ethynyl group.

Aspect 50 is the pretreated metal product of any previous or subsequent aspect, wherein the phosphorus-containing organic acids comprise a mixture of two or more different phosphorus-containing organic acids.

Aspect 51 is the pretreated metal product of any previous or subsequent spect, wherein the one or more phosphorus-containing organic acids have molecular weights of greater than or about 125 g/mol and less than or about 600 g/mol.

Aspect 52 is the pretreated metal product of any previous or subsequent aspect, wherein a molar ratio of a first phosphorus-containing organic acid in the mixture to a second phosphorus-containing organic acids in the mixture is from 1:200 to 200:1.

Aspect 53 is the pretreated metal product of any previous or subsequent aspect, wherein the phosphorus-containing organic acids consist of or consist essentially of hydroxyl-functionalized phosphorus-containing organic acids.

Aspect 54 is the pretreated metal product of any previous or subsequent aspect, wherein the phosphorus-containing organic acids consist of or consist essentially of amino-functionalized phosphorus-containing organic acids.

Aspect 55 is the pretreated metal product of any previous or subsequent aspect, wherein the one or more of the phosphorus-containing organic acids consist of or consist essentially of thiol-functionalized phosphorus-containing organic acids.

Aspect 56 is the pretreated metal product of any previous or subsequent aspect, wherein the one or more of the phosphorus-containing organic acids consist of or consist essentially of any combination of hydroxyl-functionalized phosphorus-containing organic acids, amino-functionalized phosphorus-containing organic acids, and thiol-functionalized phosphorus-containing organic acids.

Aspect 57 is the pretreated metal product of any previous or subsequent aspect, further comprising: a second product positioned adjacent to the aluminum alloy product; and a joining material providing a bond between the aluminum alloy product and the second product.

Aspect 58 is the pretreated metal product of any previous or subsequent aspect, wherein the second product is a second aluminum alloy product, a steel product, a magnesium product, a titanium product, a composite product, or a polymeric product.

Aspect 59 is the pretreated metal product of any previous or subsequent aspect, wherein the joining material comprises an epoxy adhesive, an acrylate adhesive, a rubber-based adhesive, or a polyurethane-based adhesive.

Aspect 60 is the pretreated metal product of any previous or subsequent aspect, wherein the epoxy adhesive is chemically bonded to the self-assembled monolayer or multilayer,

Aspect 61 is the pretreated metal product of any previous or subsequent aspect, wherein the bond has a greater strength, longevity, or durability as compared to a comparable bond between a comparable aluminum alloy product lacking the self-assembled monolayer or multilayer and the second product.

Aspect 62 is the pretreated metal product of any previous or subsequent aspect, wherein the joining material comprises a weld.

Aspect 63 is the pretreated metal product of any previous or subsequent aspect, wherein the aluminum alloy product includes one or more raised or recessed regions generated by subjecting the aluminum alloy product to a forming operation.

Aspect 64 is the pretreated metal product of any previous or subsequent aspect, wherein subjecting the aluminum alloy product to a forming operation includes applying a lubricant to the surface of the aluminum alloy product, wherein a contact angle of the lubricant on the surface of the aluminum alloy product with the self-assembled monolayer or multilayer s less than 90′.

Aspect 65 is the pretreated metal product of any previous or subsequent aspect, wherein the lubricant is a non-aqueous lubricant, wherein the lubricant is an aqueous lubricant, or wherein the lubricant contains the one or more phosphorus-containing organic acids in a dissolved or suspended state.

Aspect 66 is the pretreated metal product of any previous or subsequent aspect, wherein the lubricant comprises one or more of a mineral oil with or without additives, a corrosion protection oil, or a hot mehlwax.

Aspect 67 is the pretreated metal product of any previous or subsequent aspect, wherein an amount of the lubricant applied to the surface of the aluminum alloy product is from 0 to 3 g/m² or from 0.05 g/m² to 3 ₁₋₄/m²,

Aspect 68 is the pretreated metal product of any previous or subsequent aspect, wherein the contact angle is from 0° to 45°, from 0° to 20°, or from 0° to 10°.

Aspect 69 is the pretreated metal product of any previous or subsequent aspect, wherein the forming operation generates less defects in a resultant formed aluminum alloy, product as compared to a comparable forming operation using a comparable aluminum alloy product lacking the self-assembled monolayer or multilayer.

Aspect 70 is the pretreated metal product of any previous or subsequent aspect, wherein the aluminum alloy product further comprises a conversion coating over the self-assembled monolayer or multilayer.

Aspect 71 is the pretreated metal product of any previous or subsequent aspect, wherein be aluminum alloy product further comprises a chromate conversion coating or a phosphate conversion coating over the self-assembled monolayer or multilayer.

Aspect 72 is the pretreated metal product of any previous or subsequent aspect, wherein the aluminum alloy product further comprises a titanium conversion coating, a zirconium conversion coating, or a rare earth metal conversion coating over the self-assembled monolayer or multilayer.

Aspect 73 is the pretreated metal product of any previous or subsequent aspect, wherein a water contact angle of the surface having the self-assembled monolayer or multilayer is from 0° to 110°, from 0° to 45°, from 0° to 20°, or from 0° to 10°.

Aspect 74 is the pretreated metal product of any previous or subsequent aspect, wherein the aluminum alloy product is an aluminum alloy sheet.

Aspect 75 is the pretreated metal product of any previous or subsequent aspect, wherein the aluminum alloy product comprises a 5xxx series aluminum alloy, a 6xxx series aluminum alloy, a 7xxx series aluminum alloy, or an aluminum alloy cladded with a 5xxx series aluminum alloy, a 4xxx series aluminum alloy, or a lxxx series aluminum alloy.

Aspect 76 is the pretreated metal product of any previous or subsequent aspect, wherein the self-assembled monolayer or multilayer covers only a portion of the surface of the aluminum alloy product.

Aspect 77 is the pretreated metal product of any previous or subsequent aspect, wherein the self-assembled monolayer or multilayer covers an entirety of the surface of the aluminum alloy product.

Aspect 78 is the pretreated metal product of any previousaspect, generated by the method of any previous aspect.

Aspect 79 is the method of any previous aspect, comprising generating the pretreated metal product of any previous aspect.

1. A method comprising:
providing an aluminum alloy product;
applying one or more phosphorus-containing organic acids to a surface of the aluminum alloy product to generate a self-assembled monolayer or multilayer on the surface of the aluminum alloy product, wherein at least a portion of the phosphorus-containing organic acids are hydrophilic-functionalized phosphorus-containing organic acids, wherein the one or more phosphorus-containing organic acids are small molecules each having molecular weights of less than=1000 g/mol, wherein the one or more phosphorus-containing organic acids are selected from the group consisting of hydroxyl-functionalized phosphorus-containing organic acids, amino-functionalized phosphorus-containing organic acids, and sulfhydryl (thiol)-functionalized phosphorus-containing organic acids, wherein the hydroxyl-functionalized phosphorus-containing organic acids include one or more hydroxyl groups distinct from one or more hydroxyl groups directly bonded to a phosphorus atom of the hydroxyl-functionalized phosphorus-containing organic acids, and wherein the aluminum alloy product with the self-assembled monolayer or multilayer exhibits a contact angle with a lubricant of less than 90°.

2. The method of claim 1, further comprising:
applying the lubricant to the surface of the aluminum alloy product, wherein the lubricant comprises one or more of a mineral oil with or without additives, a corrosion protection oil, or a hot melt/wax.

3. The method of claim 1, wherein one or more of the phosphorus-containing organic acids are phosphonic acids.

4. The method of claim 1, wherein one or more of the phosphorus-containing organic acids have a formula of:
R—PO(OH)₂, wherein R is a functionalized or unfunctionalized alkyl group, a functionalized or unfunctionalized alkynyl group, or any combination of these.

5. The method of claim 4, wherein R is functionalized with one or more —OH groups, —NH₂ groups, —SH groups, —PO(OH)₂ groups, —PO(OH)H groups, —SO₃H groups, trialkoxysilyl groups, ethynyl groups, epoxy groups, acrylate groups, methacrylate groups, or any combination of these.

6. The method of claim 1, wherein one or more of the phosphorus-containing organic acids have a formula of:
X—(CR¹R²)—PO(OH)₂, wherein n is an integer from 3 to 30, wherein each R¹ and R² are independently a hydrogen, a functionalized or unfunctionalized alkyl group, a functionalized or unfunctionalized alkenyl group, or a functionalized or unfunctionalized alkynyl group, and wherein Xis an —OH group, an —NH₂ group, or an —SH group.

7. The method of claim 6, wherein one or more RI- or R² are functionalized with one or more —OH groups, —NH₂ groups, —SH groups, —PO(OH)₂ groups, —PO(OH)H groups, —SO₃H groups, trialkoxysilyl groups, vinyl groups, ethynyl groups, epoxy groups, acrylate groups, methacrylate groups, or any combination of these.

8. The method of claim 1, wherein one or more of the phosphorus-containing organic acids have a formula of:
X—(CH₂)ₙ—PO (OH)₂, wherein n is an integer from 3 to 30, and wherein X is an —OH group, an —NH₂ group, or an —SH group.

9. The method of claim 1, wherein the one or more phosphorus-containing organic acids have molecular weights of less than 600 g/mol.

10.-12. (canceled)

13. The method of claim 1, wherein the one or more phosphorus-containing organic acids comprise a mixture of two or more different phosphorus-containing organic acids.

14. The method of claim 13, wherein a molar ratio of a first phosphorus-containing organic acid in the mixture to a second phosphorus-containing organic acid in the mixture is from 1:200 to 200:1 or
wherein the first phosphorus-containing organic acid in the mixture comprises a hydrophilic-functionalized phosphorus-containing organic acid and wherein the second phosphorus-containing organic acid in the mixture comprises a different hydrophilic-functionalized phosphorus-containing organic acid, or
wherein the first phosphorus-containing organic acid in the mixture comprises a hydrophilic-functionalized phosphorus-containing organic acid and wherein the second phosphorus-containing organic acid in the mixture comprises a phosphorus-containing organic acid lacking a hydrophilic-functional group, or.

15.-16. (canceled)

17. The method of claim 1, wherein one or more of the phosphorus-containing organic acids comprise molecules functionalized with multiple phosphorus-containing acids, or
wherein one or more of the phosphorus-containing organic acids comprise molecules functionalized with a phosphorus-containing acid salt including a Ti, Zr, Mo, Na, K, Mg, Ca, Zn, Cr, Ce, Y, Tb, or La ion, or
wherein the one or more phosphorus-containing organic acids consist of or consist essentially of hydroxyl-functionalized phosphorus-containing organic acids, or
wherein the one or more phosphorus-containing organic acids consist of or consist essentially of amino-functionalized phosphorus-containing organic acids, or
wherein the one or more phosphorus-containing organic acids consist of or consist essentially of thiol-functionalized phosphorus-containing organic acids or
wherein the one or more phosphorus-containing organic acids consist of or consist essentially of bis-phosphorus-containing organic acids, or
wherein the one or more phosphorus-containing organic acids consist of or consist essentially of any combination of hydroxyl-functionalized phosphorus-containing organic acids, amino-functionalized phosphorus-containing organic acids, thiol-functionalized phosphorus-containing organic acids, or bis-phosphorus-containing organic acids.

18.-23. (canceled)

24. The method of claim 1, further comprising:
subjecting the aluminum alloy product to a forming operation to generate a formed aluminum alloy product; and
joining the formed aluminum alloy product to a second product to generate a joined product.

25.-27. (canceled)

28. The method of claim 24, wherein the self-assembled monolayer or multilayer increases a strength, longevity, or durability of a joint created by the joining as compared to a comparable joint between a comparable aluminum alloy product lacking the self-assembled monolayer or multilayer and the second product, or
wherein the forming operation generates less defects in the formed aluminum alloy product as compared to a comparable forming operation using a comparable aluminum alloy product lacking the self-assembled monolayer or multilayer, or
wherein the second product is a second aluminum alloy product, a steel product, a magnesium product, a titanium product, a composite product, or a polymeric product.

29. (canceled)

30. (canceled)

31. The method of claim 24, further comprising one or more of:
subjecting the joined product to a corrosive environment.
generating a conversion coating on the aluminum alloy product, the formed aluminum alloy product, or the joined product.
generating a chromate conversion coating or a phosphate conversion coating on the aluminum alloy product, the formed aluminum alloy product, or the joined product.
generating a titanium conversion coating on the aluminum alloy product, the formed aluminum alloy product, or the joined product,
a zirconium conversion coating on the aluminum alloy product, the formed aluminum alloy product, or the joined product, or
a rare earth metal conversion coating on the aluminum alloy product, the formed aluminum alloy product, or the joined product.

32.-41. (canceled)

42. The method of claim 1, wherein the self-assembled monolayer or multilayer covers only a portion of the surface of the aluminum alloy product.

43. (canceled)

44. A pretreated metal product, comprising:
an aluminum alloy product having a surface, wherein a self-assembled monolayer or multilayer is present on the surface, the self-assembled monolayer or multilayer comprising one or more phosphorus-containing organic acids bonded to the surface, wherein at least a portion of the phosphorus-containing organic acids are hydrophilic-functionalized phosphorus-containing organic acids, wherein the one or more phosphorus-containing organic acids are small molecules each having molecular weights of less than=1000 g/mol, wherein the one or more phosphorus-containing organic acids are selected from the group consisting of hydroxyl-functionalized phosphorus-containing organic acids, amino-functionalized phosphorus-containing organic acids, and sulfhydryl (thiol)-functionalized phosphorus-containing organic acids, and wherein the hydroxyl-functionalized phosphorus-containing organic acids include one or more hydroxyl groups distinct from one or more hydroxyl groups directly bonded to a phosphorus atom of the hydroxyl-functionalized phosphorus-containing organic acids.

45.-48. (canceled)

49. The pretreated metal product of claim 44, wherein the phosphorus-containing organic acids comprise a mixture of two or more different phosphorus-containing organic acids.

50. The pretreated metal product of claim 49, wherein the one or more phosphorus-containing organic acids have molecular weights of greater than or about 125 g/mol and less than or about 600 g/mol.

51.-55. (canceled)

56. The pretreated metal product of claim 44, further comprising:
a second product positioned adjacent to the aluminum alloy product; and
a joining material providing a bond between the aluminum alloy product and the second product.

57.-77. (canceled)
